(19) United States
(12) Patent Application Publication
(10) Pub. No.: US 2003/0194660 A1
(43) Pub. Date: Oct. 16, 2003

(54) Heat developable light sensitive material and image forming method

(76) Inventor: Senzou Sasaoka, Kanagawa (JP)

Correspondence Address: Sheldon J. Moss, c/o Yumi Yerks, Apartment #412-North, 2111 Jefferson Davis Highway, Arlington, VA, 22202, US

(21) Appl. No.: 10/372,287

(22) Filed: Feb. 25, 2003

(30) Foreign Application Priority Data
Feb. 27, 2002 (JP) 2002-51768

(51) Int. Cl. G03C 1/498; G03C 5/16

(52) U.S. Cl. 430/350; 430/530; 430/531; 430/619; 430/631; 430/945; 430/950; 430/961

(57) ABSTRACT

The present invention provides a heat developable light sensitive material comprising a support and a constituent layer disposed on one surface of the support and including a light sensitive layer, wherein the constituent layer includes a binder, an organic silver salt, a reducing agent for silver ion, light sensitive silver halide grains, and at least one polymer binder selected from a group consisting of polyvinyl butyral, cellulose acetate, cellulose butyrate and derivatives thereof, and a mercury content of the constituent layer is no more than 1 mg/m², and a logarithmic value of the cross sectional resistance value (Ω) of the light sensitive material is no more than 12, and a coated amount of silver is no more than 1.9 g/m², and image forming methods using the above-described heat developable light sensitive material.

### BACKGROUND OF THE INVENTION

1. Field of the Invention

The present invention concerns a heat developable light sensitive material excellent in photographic performance and transportability and, particularly, suitable to use for medical diagnosis, as well as an image forming method using the light sensitive material.

2. Description of the Related Art

In recent years, decrease in the quantity of waste liquids used for processing has been demanded strongly from the viewpoint of environmental preservation and space saving in the medical field. Moreover, there has been a need for the techniques regarding heat developable light sensitive materials which can be used in medical diagnosis and photography and can be exposed efficiently to light by a laser image setter or laser imager and can form clear black images having high resolution. According to such heat developable light sensitive materials, a thermal developing system which dose not use a developing solution, and is simpler than a developing system which uses a developing solution and does not damage the environment can be supplied to users. In the system of forming images by heating the heat developable light sensitive materials at high temperature after exposure, the light sensitive materials are transported and treated at high temperature and at high speed in order to obtain images rapidly. For this purpose, the light sensitive materials have to satisfy various requirements that they are not thermally fused during heat development, do not suffer from electrostatic marks during production, processing steps, distribution or exposure and developing treatment of the light sensitive materials and do not cause a problem of double feeding in the case of the light sensitive materials in the form of a cut sheet. In particular, in a case where the light sensitive materials are handled at high temperature and at high speed as described above, trouble caused by static electricity result in significant problems.

The technique for preventing trouble caused by static electricity includes the following. Japanese Patent Application Laid-Open (JP-A) No. 7-49543 describes a heat developable recording material provided with a layer having an internal resistivity of 5×10¹⁰ Ω/cm² as an internal conductive layer. JP-A No. 8-43988 describes a heat developable recording material in which a conductive layer having a surface resistivity of 5×10¹¹ Ω/cm² is disposed on the outermost layer of a backing layer. Further, JP-A Nos. 2000-131774, 2000-181004 and 2001-5141 describe heat developable recording materials having a low surface resistivity.

With an aim of preventing trouble caused by static electricity, conductive materials are used and examples there of include metal oxides, polymer materials having high charge density and metal foils which are well known. However, fibrous tin oxide particles disclosed in JP-A No. 4-29134 and needle-shaped fine tin oxide powder described in U.S. Pat. Nos. 5,575,957 and 5,719,016 have been proposed as materials having a higher conduction efficiency and showing effective conductivity with a smaller amount.

However, since such metal oxides have undesired effects such as fogging silver halide photographic emulsions, it is not preferable to add them to the emulsion surface side of the recording material and they are usually added to the back side. In addition, even when material oxides are added to the back side, addition of the metal oxides to the outermost layer is not preferable because fogging may be caused over time during storage if the outermost layer containing such metal oxides contacts the emulsion surface side of an adjacent light sensitive material. Therefore, metal oxides are usually added to the internal layer of the back side.

However it has been found that unexpected fogging trouble is caused during continuous film transportation, even when the conductive material is added to the internal layer. It has been known that when a conductive layer is present in the inside, charges are rather accumulated more than in the case where the conductive layer is not present since charge separation occurs easily inside of the film. While the present inventor supposes that accumulation of the charges is attributable to the above-described fogging the mechanism is not apparent. As described above, when the conductive layer is inside the film, trouble caused by accumulation of charges are low in the initial stage of the transportation. However, problems have also been revealed in that fogging occurs when a large number of light sensitive materials are transported continuously and that, when the sheet-like films are automatically transported, double feeding tends to occur easily.

Further, when mercury, which is known as favorable anti-foggant is used in the emulsion, with an aim of preventing fogging which results from unknown reasons and occurs in the continuous transportation of light sensitive materials in which such the conductive material is used in the internal layer at the back side, it has been unexpectedly found that fogging is rather worsened. While mercury is known as a metal with high conductivity, the reason for worsening the fogging is not apparent.

Accordingly, in order to prevent occurrence of trouble regarding transportation during production and processing of photographic light sensitive materials and various handlings conducted by a user, there has been a need for improvement in lowering the internal resistance by adding a conductive material to the internal layer without worsening the photographic performance.

### SUMMARY OF THE INVENTION

In view of the problems described above in the prior art, the present invention intends to provide a heat developable light sensitive material having excellent photographic performance and transportability.

The present inventors have made an intensive study in order to solve the foregoing problems and, as a result, have found that: in a conventional method of providing a conductive layer as the surface layer of a sensitive material to lower the surface resistance value in order to prevent electrification, the cross sectional resistance value is not lowered much and it is usually 10¹³ Ω or higher; that the surface resistance value is scarcely lowered when the conductive layer is disposed inside the sensitive material to lower the cross sectional resistance value; and that the surface resistance value and the cross sectional resistance value are quite different from each other. It has been further found that the above-described fogging is improved when the coated amount of silver and the amount of mercury are small and that a heat developable light sensitive material having excellent photographic performance and transportability can be obtained by the use of a polymer binder selected from polyvinyl butyrate, cellulose acetate, cellulose butyrate and derivatives thereof as the binder used in the light sensitive layer side and by lowering the logarithmic value of the cross sectional resistance value (Ω) of the light sensitive material to 12 or less. The present invention has been accomplished based on such findings.

The first aspect of the invention provides a heat developable light sensitive material comprising a support and a constituent layer disposed on one surface of the support and including a light sensitive layer, wherein the constituent layer includes a binder, an organic silver salt, a reducing agent for silver ion, light sensitive silver halide grain, and at least one polymer binder selected from a group consisting of polyvinyl butyral, cellulose acetate, cellulose butyrate and derivatives thereof, and a mercury content of the constituent layer is no more than 1 mg/m², and a logarithmic value of the cross sectional resistance value (Ω) of the light sensitive material is no more than 12, and a coated amount of silver is no more than 1.9 g/m².

The second aspect of the invention provides an image forming method comprising the step of: exposing a heat developable light sensitive material described above with a scanning laser beam thereby forming images, wherein an angle formed between the surface of the heat developable light sensitive material to be exposed and the scanning laser beam is substantially not vertical.

The third aspect of the invention provides an image forming method comprising the step of: exposing a heat developable light sensitive material described above with a scanning laser beam thereby forming images, wherein the scanning laser beam is in a longitudinal multi-mode.

### DETAILED DESCRIPTION OF THE PREFERRED EMBODIMENTS

A method of practicing the present invention and preferred embodiments thereof will be explained in details. In the present specification, numerical ranges sandwiching “to” include numerical values listed before and after “to” as a lower limit value and an upper limit value.

The heat developable light sensitive material according to the invention comprise a support and at least one constituent layer disposed on one surface of the support and containing a light sensitive layer. The at least one constituent layer contains a binder, an organic silver salt, a reducing agent for silver ion, light sensitive silver halide particles, as well as at least one polymer binder selected from polyvinyl butyral, cellulose acetate, cellulose butyrate and derivatives thereof. In a case where the constituent layer comprises two or more layers, the ingredients described above may be contained in one identical layer or may be contained in separate constituent layers. Further, in a case where the constituent layer comprises two or more layers, a constituent layer not containing the ingredient may be present.

For the heat developable light sensitive material according to the invention, it is necessary to use at least one polymer selected from polyvinyl butyrate, cellulose acetate, cellulose butyrate and derivatives thereof in at least one of the constituent layer and layer(s) disposed on another surface of the support. The content of the polymer is preferably from 10 to 90% by weight and, particularly preferably, from 20 to 80% by weight per layer containing the polymer. Among the polymers described above, preferable example of the polymer include, but are not limited to, the following compounds.

1. polyvinyl butyral

2. carboxyl group-containing derivative of polyvinyl butyral

(monomer: carboxyl group=1:1)

3. carboxyl group-containing derivative of polyvinyl butyral

(monomer: carboxyl group=1:2)

4. amino group-containing derivative of polyvinyl butyral

(monomer: amino group=1:1)

5. amino group-containing derivative of polyvinyl butyral

(monomer: amino group=1:2)

6. a derivative containing a carboxyl group and an amino group of polyvinyl butyral

(monomer: carboxyl group: amino group=1:1:1)

7. cellulose acetate

8. carboxyl group-containing derivative of cellulose acetate

(monomer: carboxyl group=1:1)

9. carboxyl group-containing derivative of cellulose acetate

(monomer: carboxyl group=1:2)

10. amino group-containing derivative of cellulose acetate

(monomer: amino group=1:1)

11. amino group-containing derivative of cellulose acetate

(monomer: amino group=1:2)

12. a derivative containing a carboxyl group and an amino group of cellulose acetate

(monomer: carboxyl group: amino group=1:1:1)

13. cellulose butyrate

14. carboxyl group-containing derivative of cellulose butyrate

(monomer: carboxyl group=1:1)

15. carboxyl group-containing derivative of cellulose butyrate

(monomer: carboxyl group=1:2)

16. amino group-containing derivative of cellulose butyrate

(monomer: amino group=1:1)

17. amino group-containing derivative of cellulose butyrate

(monomer: amino group=1:2)

18. a derivative containing a carboxyl group and an amino group of cellulose butyrate

(monomer: carboxyl group: amino group=1:1:1)

Polyvinyl butyral, cellulose acetate, cellulose butyrate or derivative thereof including the specific examples described above can be used both in the light sensitive layer and in the layer(s) other than the light sensitive layer.

The binder of the light sensitive layer in the heat developable light sensitive material according to the invention is any of natural or synthetic resins, for example, polyvinyl butyral, cellulose acetate, cellulose butyrate or derivatives thereof described above, gelatin, polyvinyl acetal, polyvinyl chloride, polyvinyl acetate, polyolefin, polyester, polystyrene, polyacrylonitrile, polycarbonate, butylethyl cellulose, methacrylate copolymer, maleic acid anhydride ester copolymer and butadiene-styrene copolymer.

Among them, polyvinyl butyral, cellulose acetate, cellulose butyrate or derivatives thereof as described above are preferable. Further, polymers exemplified below are also preferable.

1. amino group-containing derivative of polystyrene

(monomer: amino group=1:1)

2. amino group-containing derivative of polystyrene

(monomer: amino group=1:2)

3. a derivative containing a carboxyl group and an amino group of polystyrene

(monomer: carboxyl group: amino group=1:1:1)

The binder of the light sensitive layer in the invention is used in a sufficient amount to hold the ingredients therein. That is, it is used within an effective range to function as a binder. An effective range can be properly decided by those skilled in the art. As a measure in a case of holding at least an organic silver salt, the mass ratio of the binder to the organic silver salt is within a range from 15:1 to 1:3, and particularly, 8:1 to 1:2.

The heat developable light sensitive material according to the invention contains an organic silver salt. The organic silver salt usable in the invention is a silver salt that is relatively stable to light and forms silver images when heated to 80° C. or higher under the presence of an exposed photocatalyst (latent images of light sensitive silver halide, and the like) and a reducing agent. The organic silver salt may be any of organic materials containing a source capable of reducing silver ions. Such a material is preferably a silver salt of an organic acid, particularly, a silver salt of long-chain (number of carbon atoms of from 10 to 30, and preferably 15 to 28) aliphatic carboxylic acid. Further, a complex of an organic or inorganic silver salt in which a ligand has a complex stability constant of from 4.0 to 10.0 is also preferable. Such non-light sensitive organic silver salts are described, for example, in columns 0048-0049 of JP-A No. 10-62899, from page 18, line 24 to page 19 line 37 of EP-A No. 0,803,764A1, EP-A No. 0,962,812A1, JP-A Nos. 11-349591, 2000-7683 and 2000-72711. Preferable organic silver salts are silver salts of organic compounds having a carboxyl group. These compounds include, but are not limited to, silver salts of aliphatic carboxylic acids and silver salts of aromatic carboxylic acids. Preferable examples of the silver salts of the aliphatic carboxylic acids include silver behenate, silver stearate, silver oleate, silver laurate, silver capronate, silver myristate, silver palmitate, silver maleate, silver fumarate, silver tartrate, silver linoleate, silver butyrate and silver camphorate, and mixtures thereof. The amount of the organic silver salt as a silver supplying material is preferably from about 5 to 30 mass % in the image forming layer.

There is no particular restriction on the shape of the organic silver salt usable in the invention and needle-shaped crystals each having a minor axis and a major axis are preferable. In the technical field of silver halide photosensitive materials, an inverse proportional relation between the size of silver salt crystal particles and the covering power thereof has been well known. This relation is also established in the heat developable light sensitive material of the invention, which means that the larger organic silver salt particles as the image forming component of the heat developable light sensitive material are, the lower the covering power and the image density are. Accordingly, it is preferable to reduce the size of the organic silver salt. In the invention, it is preferable that the minor axis is 0.01 μm to 0.20 μm and that the major axis is 0.10 μm to 5.0 μm, and that it is more preferable that the minor axis is 0.01 μm to 0.15 μm and that the major axis is 0.10 μm to 4.0 μm. It is preferable that the distribution of the grain size of the organic silver salt is monodisperse. Monodisperse means that the percentage of the values obtained by dividing the standard deviation for the minor axes by the minor axis and by dividing the standard deviation for the major axes by the major axis are 100% or less, preferably 80% or less and and more preferably 50% or less. As a method of measuring the shape of the organic silver salt, there is a method of determining the shape by transmission electron microscopic images of the organic silver salt dispersion. As another method of measuring the monodispersibility property, there is a method of determining the monodispersibility from the standard deviation of the volume weighted mean diameter of an organic silver salt and in this case monodisperse means that the percentage of the value obtained by dividing the standard deviation by the volume weighted mean diameter (fluctuation coefficient) is 100% or less, preferably 80% or less and more preferably 50% or less. The measuring method can be a method in which an organic silver salt dispersed in a liquid is exposed to a laser beam, and the fluctuation coefficient is obtained from the grain size gained by determining a self-correlation function of the fluctuation of the scattered light relative to the change of time (volume weighted mean diameter).

A coated amount of the organic silver salt silver is 1.9 g/m² or less, preferably from 0.1 to 1.9 g/m² and more preferably 0.5 to 1.4 g/m². If the amount exceeds 1.9 g/m², it increases fogging and worsens the transportability.

The heat developable light sensitive material according to the invention contains a reducing agent for a silver ion of an organic silver salt. The reducing agent for a silver ion is any material capable of reducing a silver ion into metallic silver, and preferably an organic material. While existent photographic developer such as phenidone, hydroquinone and catechol is useful for the reducing agent for a silver ion, o-bisphenol reducing agent is preferable. Example of the o-bisphenol reducing agent include bis(2-hydroxy-3-t-butyl-5-metylphenyl)methane, 2,2-bis(4-hydroxy-3-methylphenyl)propane, 4,4-ethylidene-bis(2-t-butyl-6-methylphenol), 1,1-bis(2-hydroxy-3,5-dimethylphenyl)-3,5,5-trimethylhexane, bis(2-hydroxy-3-t-butyl-5-ethylphenyl)methane, 1,1-bis(2-hydroxy-3-t-butyl-5-methylphenyl)butane, 1,1-bis(2-hydroxy-3,5-dimethylphenyl)-2-methylpropane, and 2,2-bis(3,5-dimethyl-4-hydroxyphenyl)propane. The reducing agent is preferably contained in an amount of 5 to 50 mol % based on 1 mol of silver of an image forming layer side and it is more preferably contained in an amount of 10 to 40 mol %. The layer to which the reducing agent is added may be any layer of the image forming layer side and is preferably the image forming layer.

The heat developable light sensitive material according to the invention contains light sensitive silver halide grains. The method of forming the light sensitive silver halide used in the invention is well-known in the art and a method described, for example, in Research Disclosure No. 17029, 1978, June: and U.S. Pat. No. 3,700,458 can be used as such. The concrete method usable in the invention include a method of adding a halogen-containing compound to a prepared organic silver salt thereby converting a portion of silver in the organic silver salt into a light sensitive silver halide, and a method of adding a silver supplying compound and a halogen supplying compound to a gelatin or other polymer solution thereby preparing light sensitive silver halide particles and mixing them with an organic silver salt. In the invention, use of the latter method is preferable. The size of the light sensitive silver halide grains is preferably small with an aim of suppressing clouding after image formation and specifically it is preferably from 0.0001 μm to 0.15 μm and more preferably 0.02 μm to 0.10 μm. When the silver halide grain size is excessively small, the sensitivity sometimes be insufficient and if the size is excessively large, the haze of the light sensitive material may increase. The grain size referred to herein is a length of the edge of the silver halide grain in a case where the silver halide grains are normal crystals such as cube or octahedron. In a case where the silver halide grains are tabular, the grain size means a diameter of a circle having the same area as the projected area of the main surface. Further, in a case of not-normal crystals, for example, in a case of spherical particles or rod-shaped particles, the grain size means a diameter of a sphere equivalent to the volume of a silver halide grain.

The shape of the silver halide grains include cube, octahedron, tabular grain, spherical grain, rod-shaped grain and potato-shaped grain. In the invention, cubic grains or tabular grains are particularly preferable. In a case of tabular silver halide grains, the average aspect ratio thereof is preferably from 100:1 to 2:1 and more preferably 50:1 to 3:1. Further, silver halide grains having round corners can also be preferably used. There is no particular restriction on the plain index (Miller index) of the outer surface of the light sensitive silver halide grains and it is preferable that percentage of [100] plain having high spectral sensitizing efficiency in a case of adsorbing spectral sensitizing dye is high. The percentage is preferably 50% or more, more preferably 65% or more and further preferably 80% or more. The Miller index of percentage of the [100] plain can be determined by a method as described in T. Tani; J. Imaging Sci., 29, 165 (1985) utilizing the adsorption dependence of [111] plain and [100] plain in the adsorption of the sensitizing dye. There is no particular restriction on the halogen composition of the light sensitive silver halide and it may be any of silver chloride, silver chlorobromide, silver bromide, silver iodobromide, silver iodochlorobromide and silver iodide. In the invention, silver bromide or silver iodebromide can be preferably used. Silver bromoiodide is particularly preferable and the content of sliver iodide is preferably 0.1 mol % to 40 mol %, and more preferably 0.1 mol % to 20 mol %. The distribution of the halogen composition in the grains may be uniform, or the halogen composition may be stepwise or continuously changed in the grains. Use of silver iodobromide grains having high silver iodide content inside of the grains is preferable. Further, use of silver halide grains having a core/shell structure is also preferable. As for the structure, core/shell grains preferably having a two to five-layered structure and, more preferably a two to four-layered structure can be used.

The light sensitive silver halide grains used in the invention preferably contain at least one of complexes of metals selected from rhodium, rhenium, ruthenium, osmium, iridium, cobalt or iron. The metal complex may be used alone, or two or more of complexes whose metals are the same or different may be used together. A content of the metal complex is preferably within a range from 1 mmol to 10 mmol and more preferably within a range from 10 mmol to 100 μ mol based on one mol of silver. As for a specific structure of the metal complex, a metal complex with a structure described in JP-A No. 7-225449, and the like can be used. Hexacyano metal complexes can be preferably used as cobalt and iron compounds. Specific examples thereof include, but are not limited to, a ferricyanate ion, a ferrocyanate ion, a hexacyanocobaltate acid ion. The metal complex may be uniformly contained in whole portions of silver halide grains, or the concentration of the metal complex in the core of the grains may be higher or lower than that in shell portion of the grains, and its inclusion state is not limited.

The light sensitive silver halide grains can be desalted by washing with water by any method known in the art such as a noodle method and a flocculation method, or may not be desalted.

Preferably, the light sensitive silver halide grains in the invention are chemically sensitized. Examples of chemical sensitizing method include a sulfur sensitizing method, a selenium sensitizing method and a tellurium sensitizing method which are well-known in the art. Further, a noble metal sensitizing method using, for example, a gold compound, platinum, palladium, or an iridium compound or a reduction sensitizing method can be used. Any known compound can be used in the sulfur sensitizing method, the selenium sensitizing method or the tellurium sensitizing method and compounds described, for example, in JP-A No. 7-128768 can be preferably used as such.

The amount of the light sensitive silver halide used in the invention is preferably 0.01 mol to 0.5 mol, preferably 0.02 mol to 0.3 mol and particularly preferably 0.03 mol to 0.25 mol per mol of the organic silver salt. The mixing method and the mixing condition for the light sensitive silver halide and the organic silver salt prepared separately is not limited so long as the effect of the invention can be obtained sufficiently. However, examples thereof include a method of mixing the silver halide grains and the organic silver salt prepared separately by a high speed stirrer, ball mill, sand mill, colloid mill, vibration mill or homogenizer and a method of mixing the prepared light sensitive sliver halide with the organic silver salt which is being prepared at any timing.

A so-called halidation method of halogenating a portion of silver in the organic silver salt with an organic or inorganic halide is preferably used as a method of preparing the silver halide used in the invention. Any organic halide that reacts with an organic silver salt to form a silver halide may be used and examples thereof include N-halogenoimide (such as N-bromosuccinimide), a halogenated quaternary nitrogen compound (such as tetrabutyl ammonium bromide), and an association of a halogenated quaternary nitrogen salt and a halogen molecule (such as pyridinium perbromide). Any inorganic halide that reacts with an organic silver salt to form a silver halide can be used and examples thereof include alkali metal halide and ammonium halide (such as sodium chloride, lithium bromide, potassium iodide, and ammonium bromide), alkaline earth metal halide (such as calcium bromide, and magnesium chloride), transition metal halide (such as ferric chloride, and cupric bromide), metal complex having halogen ligand (such as sodium bromoiridate, and ammonium chlororhodate), and halogen molecules (bromine, chlorine and iodine). Further, a desired organic or inorganic halide may be used together. The addition amount of a halogen atom of the halide in halidation is preferably from 1 mmol to 500 mmol, and more preferably 10 mmol to 250 mmol based on one mol of the organic silver salt.

In the invention, a sensitizing dye is preferably used. Any sensitizing dye which spectrally sensitizes silver halide grains at a desired wavelength region when adsorbed by silver halide grains, and has spectral sensitivity suitable to spectral characteristic of an exposure light source can be selected advantageously. Examples of the sensitizing dye and the addition method include compounds described in the columns 0103 to 0109 in JP-A No. 11-65021, compounds represented by the general formula (II) in JP-A No. 10-186572, dyes represented by the general formula (I) and described in column 0106 in JP-A No. 11-119374, dyes described in U.S. Pat. Nos. 5,510,236 and 5,541,054, and in Example 5 of U.S. Pat. No. 3,871,887, dyes disclosed in JP-A Nos. 2-96131 and 59-48753, dyes described in page 19, line 38 to page 20, line 35 in EP-A No. 0,803,764A1 and in Japanese Patent Application Nos. 2000-86865 and 2000-102560. The sensitizing dyes may be used alone or two or more of them may be used in combination. The addition amount of the sensitizing dye in the invention may be determined in accordance with the sensitivity or fogging preventing performance and it is preferably from 10⁻⁶ to 1 mol and more preferably 10⁻⁴ to 10⁻¹ mol based on one mol of the silver halide in the light sensitive layer. A combination of the sensitizing dyes is often used with an aim of super-sensitization. A dye not having the spectral sensitizing effect per se or a material not substantially absorbing visible rays but showing super-sensitization may be incorporated together with the sensitizing dye in an emulsion. Useful combination of the sensitizing dye and the super-sensitization dye, and materials showing super-sensitization are described, for example, in Research Disclosure vol. 176, 17643 (published in December, 1978), page 23, paragraph IV-J, or in Japanese Patent Application Publication (JP-B) Nos. 49-25500 and 43-4933, and JP-A Nos. 59-19032 and 59-192242.

A method of measuring the cross sectional resistance in the invention will be described hereinafter.

<Method of Measuring Cross Sectional Resistance (Hereinafter Simply Referred to as ER)>

A test material is cut into rectangular parallelopiped having a length of 1 cm and a width of 5 cm, and a conductive paint (Dotite D-550 manufactured by Fujikura Kasei Co.) is applied to the edges along its width, dried and the cut test material is then allowed to stand under temperature and humidity suitable for measurement for 12 hours. Then, both ends of the parallelepiped are connected with a circuit, with the portions of the parallelepiped, which were coated with the conductive paint, as electrodes. Using an Electrometer TR8651, manufactured by Takeda Riken, resistance is measured after applying current for one minute. The resistance (Ω) is obtained by the following formula and is expressed as a logarithmic value.

Measured electrical resistance (Ω)×electrode length (cm)÷distance between electrodes (cm)=ER value (Ω)

The cross sectional resistance value of the light sensitive material of the invention is 10¹² Ω or less. That is, a logarithmic value thereof is 12 or less and is preferably 11 or less. The cross sectional resistance value can be controlled by slecting the kind and the amount of the conductive metal compound and the conductive polymer used.

In the invention, a conductive metal compound and a conductive polymer are preferably used and they have an antistatic effect. Examples of the conductive metal compound include metal oxides and composite oxides thereof as described in JP-A Nos. 56-143430, 56-143431, 57-104931, and 57-118242. Metal oxides and composite oxides thereof are preferable as the conductive metal compound and examples thereof include particles of at least one crystalline metal oxide selected from ZnO, TiO₂, SnO₂, Al₂O₃, In₂O₃, MgO, BaO, MoO₃, Sio₂ and ZrO₂ which contain a small amount of heteroatom and whose average grain size is 0.05 to 0.5 μm, and composite oxides thereof.

Typical combinations of a metal oxide and a heteroatom are ZnO and Al or In, TiO₂ and Nb or Ta, SnO₂ and Sb or Nb or halogen atom. The addition amount of the heteroatom is preferably within a range from 0.01 to 30 mol % and more preferably within 0.1 to 10 mol %. If the addition amount is less than 0.01 mol %, the oxides or the composite oxides cannot be provided with a sufficient conductivity and, on the other hand, when it is more than 30 mol %, photographic density of the particles increases and the conductive layer appears black and cannot be used for photography. In particular, metal oxides having a fibrous crystal form as disclosed in JP-A No. 4-29134 and metal oxides having a needle-shaped crystal form as disclosed in U.S. Pat. Nos. 5,575,957 and 5,719,016 are preferable since they can provide high conductivity with a small amount and give no somberness to the vacuum layer. It is most preferable that the conductive metal is tin oxide, zinc oxide, titanium oxide or vanadium pentaoxide.

Examples of the conductive polymer include those described in JP-A No. 48-22017, JP-B No. 46-24159, JP-A Nos. 51-30725, 51-129216, 55-95942, 49-3972, 49-121523, 48-91165, JP-B No. 49-24582, and JP-A No. 56-117234.

Examples of the antistatic agent other than the conductive metal compound and the conductive polymer include ionic or nonionic surfactants and colloidal silica. Examples of such surfactants include those described, for example in JP-A Nos. 49-85826, 49-33630, U.S. Pat. Nos. 2,992,108 and 3,206,312, JP-A No. 48-87826, JP-B Nos. 49-11567 and 49-11568, and JP-A No. 55-70837. Further, colloidal silica as described in U.S. Pat. No. 3,525,621 and alumina sol as described in JP-A No. 58-58541 can also be used as the antistatic agent.

The antistatic agent such as the conductive metal compound and the conductive polymer is used in an amount of from 1 mg/m² to 1 g/m², and preferably 50 mg/m² to 500 mg/m².

It is preferable to add a color controlling agent to the heat developable light sensitive material according to the invention and the color controlling agent is described in columns 0054 to 0055 in JP-A No. 10-62899, page 21, lines 23 to 48 in EP-A No. 0,803,764A1 and JP-A No. 2000-35631. In particular, phthalazinones (phthalazinone, phthalazinone derivative and metal salt thereof; for example, 4-(1-naphthyl)phthalazinone, 6-chlorophthalazinone, 5,7-dimethoxyphthalazinone and 2,3-dihydro-1,4-phthalazindione); combination of phthalazinone and phthalic acid or a derivative thereof (for example, phthalic acid, 4-methylphthalic acid, 4-nitrophthalic acid and tetrachlorophthalic acid anhydride); phthalazines (phthalazine, a phthalazine derivative or a metal salt thereof; for example, 4-(1-naphtyl)phthalazine, 6-isopropylphthalazine, 6-t-butylphthalazine, 6-chlorophthalazine, 5,7-dimethoxyphthalazine and 2,3-dihydrophthalazine); and combination of phthalazine and phthalic acid or a derivative thereof are preferable, and the combination of phthalazine and phthalic acid or a derivative thereof is particularly preferable. The color controlling agent is preferably contained in an amount of 0.1 to 50 mol % and, more preferably in an amount of 0.5 to 20 mol % per mol of silver in an image forming layer side.

The heat developable light sensitive material according to the invention preferably contains in any one of the constituent layers thereof at least one compound selected from aziridine compounds as described in U.S. Pat. No. 3,017,280 and JP-A No. 9-5916, epoxy compounds as described in U.S. Pat. No. 3,017,280 and JP-A No. 9-5916 and carbodiimide compounds as described in U.S. Pat. No. 3,100,704. The compounds described above function as a film hardening agent and has an effect of increasing the film strength of the heat developable light sensitive material.

A compound having an aziridine group that can be used in the invention will be described hereinafter. In the invention, any compound having an aziridine group and having the film hardening effect can be used and it is preferable to use the following specific compounds in the invention.

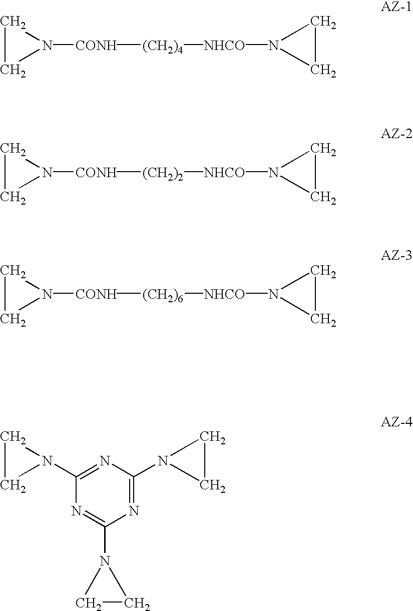

Then, the compound having an epoxy group that can be used in the invention will be described hereinafter. In the invention, any compound having an epoxy group and film hardening effect can be used and epoxy compounds having a hydroxyl group or ether condensation are preferable. Typical examples of such compounds are shown below.

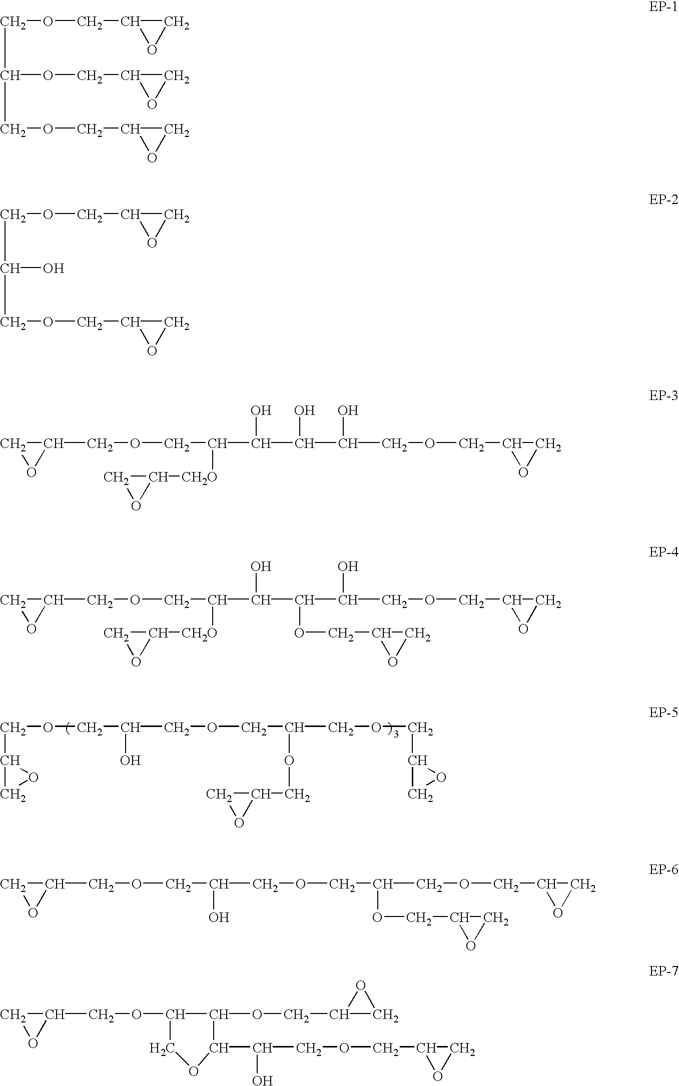

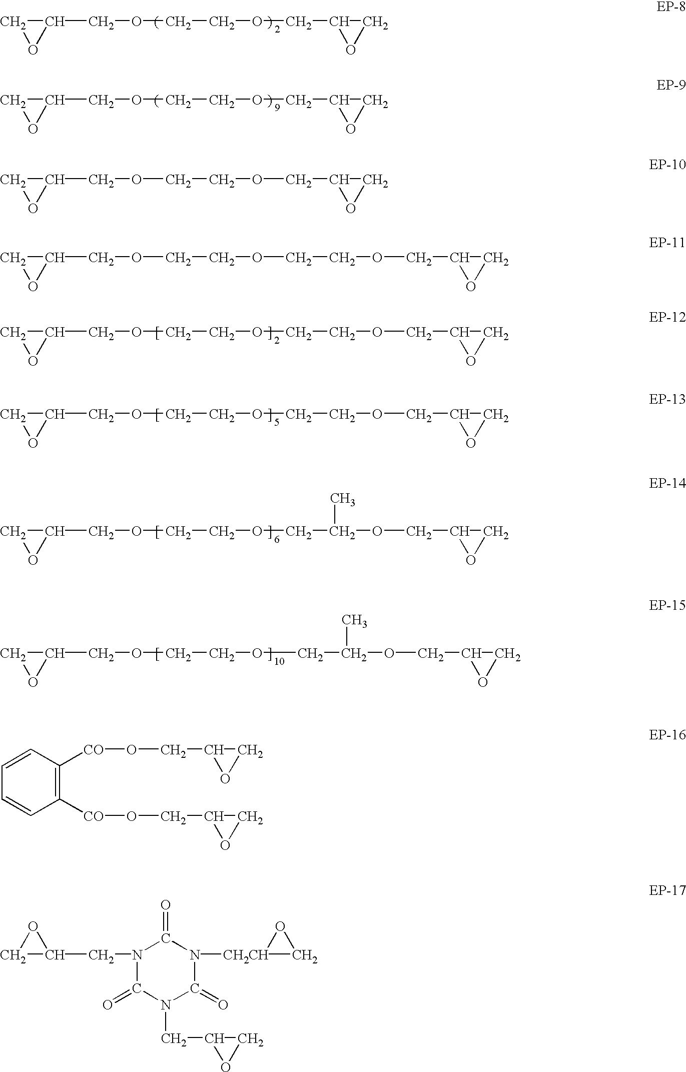

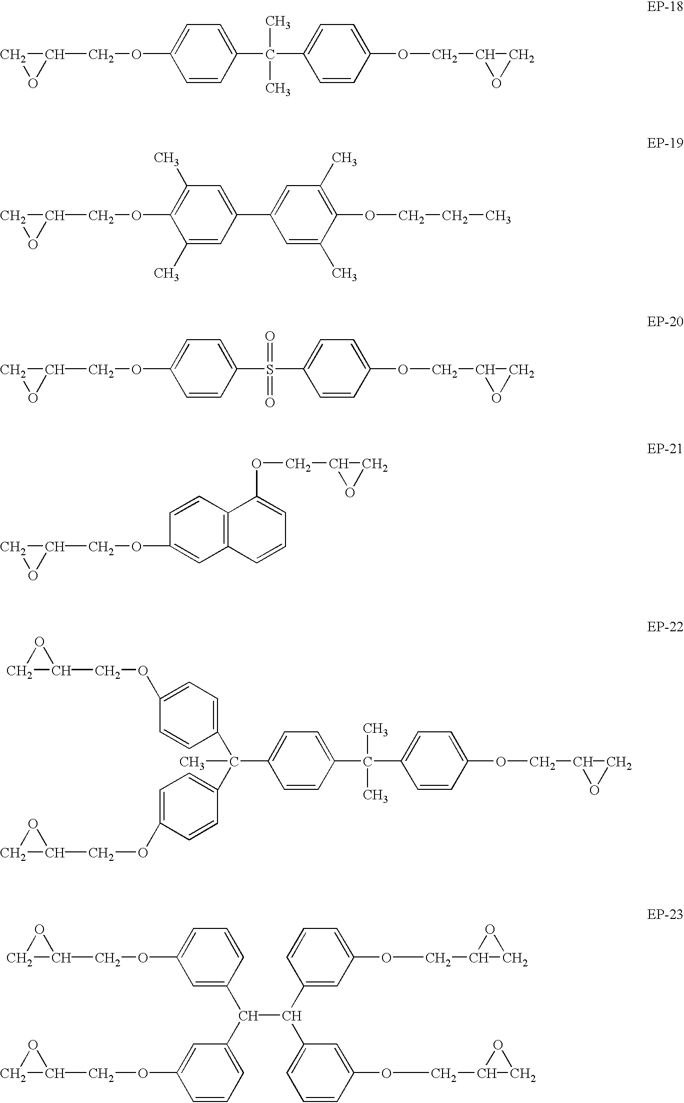

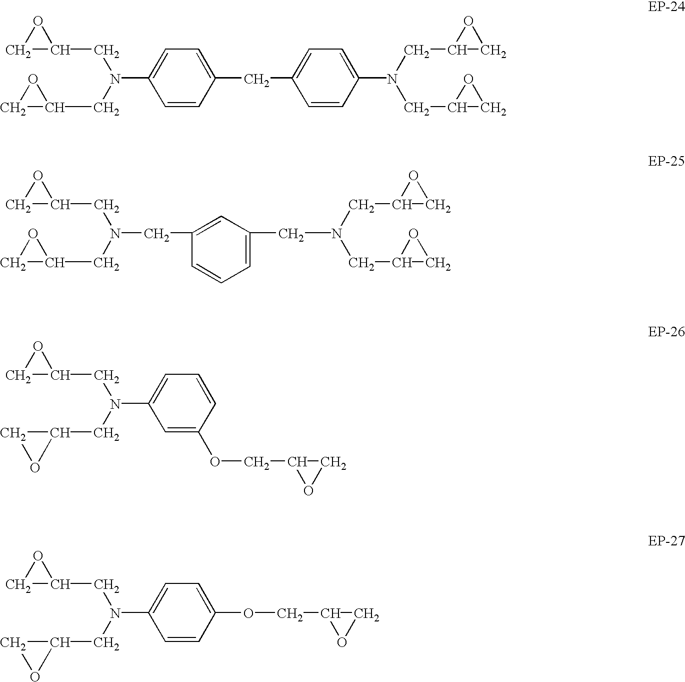

Most of the compounds described above are commercially available and can be obtained easily. The compound having an epoxy group described above can be added in the form of a solution obtained by dissolving the compound in an organic solvent such as alcohol, acetone, or toluene, or water or a dispersion in which the compound is dispersed in a solvent with a surfactant such as a dodecylbenzene sulfonate or nonylphenoxy alkylene oxide.

In the invention, carbodiimide compounds can also be used in addition to those described above, and preferred carbodiimide compounds are represented by the following general formula.

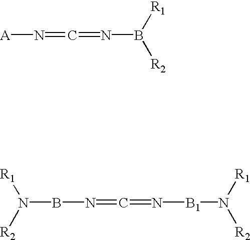

In the general formula described above, A represents an aliphatic group (for example, methyl group, ethyl group, isopropyl group, n-butyl group, isobutyl group, t-butyl group, allyl group, crotyl group, β-hydroxyethyl group, and methoxymethyl-β-bromoallyl group), an aromatic group (for example, phenyl group, tolyl group, xylyl group, naphtyl group, chlorophenyl group, bromophenyl group and iodophenyl group), an alicyclic group (for example, cyclohexyl group, bornyl group and menthyl group) or a heterocyclic ring group (for example, pyridyl group, and quinolyl group). R₁ and R₂ independently represent a lower alkyl group, for example, methyl group, ethyl group, propyl group, isopropyl group or butyl group, and B and B₁ (which may be the same as or different from each other) independently represent an alkylene group, an allylene group or an aralkylene group, for example, propylene group, phenylene group, tolylene group or propylphenylene group.

The di-substituted carbodiimides are obtained by treating N,N′-di-substituted symmetric or asymmetric thiourea having at least one tertiary amino group with a desulfurizing agent such as an oxide of heavy metal including lead or mercury as described in Berichte, Vol. 71, PP.1512-1521, Vol. 73, PP.467-477, PP.1114-1123, Vol. 75 PP.100-105, Annalen, Vol. 560, PP.222-231, and Journal of Organic Chemistry, Vol. PP.1024-1026.

Typical compounds thereof include N-isopropyl-N′-(4-dimethylaminophenyl) carbodiimide, N-phenyl-N′-(4-dimethylaminophenyl) carbodiimide, N,N′-di(4-dimethylaminophenyl) carbodiimide, N,N′-di(4-dipropylaminotolyl) carbodiimide, N-bornyl-N′-(4-dimethylaminophenyl) carbodiimide, N-menthyl-N′-(4-dimethylaminophenyl) carbodiimide, N-(β-bromoallyl) —N′-(γ-dimethylaminophenyl) carbodiimide, N-(t-butyl)-N′-(γ-dimethylaminophenyl) carbodiimide, N-cyclohexyl-N′-(4-dimethylaminophenyl) carbodiimide, N-isopropyl-N′-(γ-dimethylaminopropyl) carbodiimide, N-methoxymethyl-N′-(γ-dimethylaminopropyl) carbodiimide, and N,N′-di(γ-pyridyl) carbodiimide.

The N,N′-di-substituted carbodiimides having the tertiary amine may be converted into quaternary ammonium salts by reacting them with an appropriate quaternarizing agent, for example, methyl bromide, ethyl bromide, methyl iodide, ethyl iodide, dimethylsulfuric acid, diethylsulfuric acid, methyl p-toluenesulfonate and ethyl p-toluenesulfonate directly or in the presence of ethyl acetate, chloroform, benzene or toluene, or a mixed solvent thereof, by which the solubility can be controlled. They may be added in the form of a quaternary salt.

Typical examples of quaternarized N,N′-di-substituted carbodiimides include N-isopropyl-N′-(4-dimethylaminophenyl) carbodiimide ethyl p-toluenesulfonate, N-phenyl-N′-(4-dimethylaminophenyl) carbodiimide ethyl p-toluenesulfonate, N,N′-di(4-dimethylaminophenyl) carbodiimide monoethobromide, N,N′-di(4-dipropylaminotolyl) carbodiimide ethyl p-toluenesulfonate, N-bornyl-N′-(4-dimethylaminophenyl) carbodiimide methosulfate, N-methyl-N′-(4-dimethylaminophenyl) carbodiimide ethosulfate, N-γ-bromoallyl)-N′-(γ-dimethylaminophenyl) carbodiimide ethosulfate, N-(t-butyl)-N′-(γ-dimethylaminophenyl) carbodiimide ethyl p-toluenesulfonate, N-cyclohexyl-N′-(4-dimethylaminophenyl) carbodiimide ethyl p-toluenesulfonate, N-isopropyl-N′-(γ-dimethylaminopropyl) carbodiimide ethobromide, N-methoxymethyl-N-(γ-dimethylaminopropyl) carbodiimide ethyl p-toluenesulfonate, and N,N′-di(γ-pyridyl) carbodiimide monomethosulfate.

Generally, the hardening agent such as an aziridine compound, an epoxy compound and a carbodiimide compound is used in an amount of 0.002 mol or more based on one mol of silver. Usually, the hardening agent is used in an amount of 0.002 to 2 mol and preferably 0.003 to 0.3 mol based on one mol of silver.

The film hardening agent described above can be used in each of the layers such as a light sensitive layer, a protection layer and a back layer in the invention. Examples of the film hardening agent include, in addition to those described above, polyisocyanates described in U.S. Pat. No. 4,281,060, and JP-A No. 6-208193, epoxy compounds as described in U.S. Pat. No. 4,791,042 and vinyl sulfone compound as described in JP-A No. 62-89048.

The silver halide emulsion and/or organic silver salt used in the invention is further protected against the formation of additional fogging by an anti-foggant, a stabilizer and a stabilizer precursor and can be stabilized against lowering of the sensitivity during storage. Examples of the anti-foggant, stabilizer and stabilizer precursor which can be used alone or in combination include thiazonium salts described in U.S. Pat. Nos. 2,131,038 and 2,694,716, azaindene described in U.S. Pat. Nos. 2,886,437 and 2,444,605, compounds described in JP-A No. 9-329865 and U.S. Pat. No. 6,083,681, mercury salt described in U.S. Pat. No. 2,728,663, urazole described in U.S. Pat. No. 3,287,135, sulfocatechol described in U.S. Pat. No. 3,235,652, oxime, nitron, nitroindazole described in British Patent No. 623 448, polyvalent metal salts described in U.S. Pat. No. 2,839,405, thiuronium salt as described in U.S. Pat. No. 3,220,839 palladium, platinum and gold salt described in U.S. Pat. Nos. 2,566,263 and 2,597,915, halogen-substituted organic compound described in U.S. Pat. Nos. 4,108,665 and 4,442,202, triazine described in U.S. Pat. Nos. 4,128,557, 4,137,079, 4,138,365 and 4,459,350, and phosphorous compound as described in U.S. Pat. No. 4,411,985.

The anti-foggant preferably used in the invention is organic halides. Among all, polyhalomethyl compound, particularly, trihalomethylsulfone compound is preferable. Examples of the organic halide include compounds as disclosed in JP-A Nos. 50-119624, 50-120328, 51-121332, 54-58022, 56-70543, 56-99335, 59-90842, 61-129642, 62-129845, 6-208191, 7-5621, 7-2781, 8-15809, 9-160167, 9-244177, 9-244178, 9-258367, 9-265150, 9-319022, 10-171063, 11-212211, 11-231460, and 11-242304, U.S. Pat. Nos. 5,340,712, 5,369,000, and 5,464,737 and specifically include 2-(tribromomethylsulfone) quinoline, 2-(tribromomethylsulfone) pyridine,tribromomethylphenylsulfone, tribromomethylnaphtylsulfone.

The heat developable light sensitive material of the invention may contain benzoic acid or a derivative thereof with an aim of increasing the sensitivity or preventing fogging. Benzoic acid and any of benzoic acid derivatives can be used as such and preferable compounds includ compounds described in U.S. Pat. Nos. 4,784,939 and 4,152,160, and JP-A Nos. 9-281637, 9-329864 and 9-329865. The benzoic acid or derivative thereof used in the invention may be added to any portion of the light sensitive material and preferably added to any layer on the light sensitive layer side and more preferably added to an organic sliver salt-containing layer. The benzoic acid or derivative thereof may be added at any step in the preparation of a coating solution. In a case of adding it to an organic silver salt containing layer, the benzoic acid or derivative thereof may be added at any step of the process from the preparation of the organic silver salt to the preparation of the coating solution and is preferably added from after preparation of the organic silver salt to just before coating. The benzoic acid or derivative thereof may be added in the form of powder, a solution and a dispersion of fine particles. Further, they may be added in the form of a solution mixed with other additive such as a sensitizing dye, a reducing agent and a color controlling agent. The benzoic acid or derivative thereof may be added in any amount and preferably in an amount of 1 μmol to 2 mol and more preferably in an amount of 1 mmol to 0.5 mol per mol of silver.

It has been unexpectedly found that fogging is rather worsened when mercury known as a preferred antifoggant is used in the emulsion of the heat developable light sensitive material of the invention with an aim of preventing fogging. Accordingly, the content of mercury in the heat developable light sensitive material of the invention has to be 1 mg/m² or less and particularly preferably 0.5 mg/m² or less.

In the invention, a mercapto compound, a disulfide compound or thione compound may be incorporated in the light sensitive material with an aim of controlling the development by suppressing or promoting development, improving the spectral sensitizing efficiency or improving the storability before and after development.

In the case of using the mercapto compound in the invention, the mercapto compound with any structure can be used but those represented by Ar—SM or Ar—S—S—Ar are preferable. In the formulae, M represents a hydrogen atom or an alkali metal atom, and Ar represents an aromatic ring or condensed aromatic ring having at least one nitrogen, sulfur, oxygen, selenium or tellurium atom. Typical examples of the heterocyclic aromatic rings include benzimidazole, naphthoimidazole, benzothiazole, naphthothiazole, benzoxazole, naphthoxazole, benzoselenazole, benzotellurazole, imidazole, oxazole, pyrazole, triazole, thiadiazole, tetrazole, triazine, pyrimidine, pyridazine, pyrazine, pyridine, purine, quinoline and quinazolinone. The heterocyclic aromatic rings may have at least one substituent selected from halogen (for example, Br and Cl), hydroxyl, amino, carboxyl, alkyl (for example, having one or more carbon atoms, preferably, 1 to 4 carbon atoms) and alkoxy (for example, having one or more carbon atoms, preferably, 1 to 4 carbon atoms). Examples of the mercapto-substituted heterocyclic aromatic compounds include, but are not limited to, 2-mercaptobenzimidazole, 2-mercaptobenzoxazole, 2-mercaptobenzothiazole, 2-mercapto-5-methylbenzimidazole, 6-ethoxy-2-mercaptobenzothiazole, 2,2′-dithiobis-benzothiazole, 3-mercapto-1,2,4-triazole, 4,5-diphenyl-2-imidazolethiole, 2-mercaptoimidazole, 1-ethyl-2-mercaptobenzimidazole, 2-mercaptoquinoline, 8-mercaptopurine, 2-mercapto-4(3H)-quinazolinone, 7-trifluoromethyl-4-quinolinethiole, 2,3,5,6-tetrachloro-4-pyridinethiole, 4-amino-6-hydroxy-2-mercaptopyrimidine monohydrate, 2-amino-5-mercapto-1,3,4-thiadiazole, 3-amino-5-mercapto-1,2,4-triazole, 4-hydroxy-2-mercaptopyrimidine, 2-mercaptopyrimidine, 4,6-diamino-2-mercaptopyrimidine, 2-mercapto-4-methylpyrimidinehydrochloride, 3-mercapto-5-phenyl-1,2,4-triazole, and 2-mercapto-4-phenyloxazole. The addition amount of the mercapto compound is preferably within a range from 0.001 to 1.0 mol and further preferably from 0.01 to 0.3 mol per mol of silver in the light sensitive layer.

The plastisizer and the lubricant that can be used in the light sensitive layer in the invention are described in column 0117 of JP-A No. 11-65021, the super contrasting agent for super contrasty image formation and addition method thereof are described in column 0118 of JP-A No. 11-65021, columns 0136 to 0193 of JP-A No. 11-223898, compounds of the formulae (H), formulae (1) to (3) and formulae (A) and (B) in Japanese Patent Application No. 11-87297, and compounds of the general formulae (III)-(V) described in Japanese Patent Application No. 11-91652 (specific compounds: chemical formula 21 to chemical formula 24), and a contrasting promoter is described in column 0102 of JP-A No. 11-65021, and columns 0194 to 0195 of JP-A No. 11-223898.

The light sensitive layer containing the light sensitive silver halide grains in the invention preferably has absorption (light absorption) of 0.1 to 0.6 and more preferably 0.2 to 0.5 at an exposure wavelength. When the absorption is too large, Dmin increases, lowering contrast, whereas when the absorption is too small, sharpness is lost. while any method may be adopted for providing the light sensitive layer in the invention with absorption, use of a dye is preferable. Any dye may be used so long as it can satisfy the absorption condition described above and examples thereof include pyrazoloazole dye, anthraquinone dye, azo dye, azomethine dye, oxonol dye, carbocyanine dye, styryl dye, triphenylmethane dye, indoaniline dye, indophenol dye and squarylium dye. The dye preferably used in the invention can be anthraquinone dye (for example, compounds 1-9 described in JP-A No. 5-341441, compounds 3-6 to 3-18 and 3-23 to 3-38 described in JP-A No. 5-165147), azomethine dye (compounds 17-47 described in JP-A No. 5-341441), indoaniline dye (for example, compounds 11-19 described in JP-A No. 5-289227, compound 47 described in JP-A No. 5-341441, and compounds 2-10 to 2-11 described in JP-A No. 5-165147), azo dye (compounds 10-16 described in JP-A No. 5-341441) and squarylium dye (compounds 1-20 described in JP-A No. 10-104779, and compounds 1a-3d described in U.S. Pat. No. 5,380,635). The dyes may be added by any method in the form of a solution, an emulsion, a dispersion of fine solid particles and in a state mordanted with a polymeric mordant. The amount of the compound used is determined depending on the aimed absorption amount and it is generally preferably within a range of 1 μg to 1 g per 1 m² of the light sensitive layer.

In the invention, absorption (light absorption) of any of the constituent layers other than the light sensitive layer containing the light sensitive silver halide particles at the exposure wavelength is preferably 0.1 to 3.0 and more preferably 0.3 to 2.0 in view of anti-halation. A portion having the light absorption of the range described above at the exposure wavelength is preferably a layer on the surface of the support which surface is opposite to the surface with the light sensitive layer (back layer, undercoating or subbing layer for the back surface, protective layer for the back layer) or a portion between the light sensitive layer containing the light sensitive silver halide grains and the support (undercoating or subbing layer).

In a case where the light sensitive silver halide particles are spectrally sensitized to the infrared region, any method may be used for providing absorption to a portion other than the light sensitive layer and it is preferable that the absorption maximum in the visible region is 0.3 or less. Examples of the dye for providing the absorption to the portion other than the light sensitive layer include those identical with the dyes that can be used for providing the absorption to the light sensitive layer, and the dye for providing the absorption to the portion other than the light sensitive layer may be the same as or different from the dye used in the light sensitive silver halide layer.

In a case where the light sensitive silver halide grains are spectrally sensitized to the visible region, any method may be used for providing absorption to a portion other than the light sensitive layer and a method using a dye that is discolored by the heat treatment or a combination of a compound for discoloring a dye and the dye to be discolored is preferable. Examples of the dye to be discolored and the compound for discoloring the dye include, but are not limited to, those described in JP-A Nos. 52-139136, 53-132334, 56-501480, 57-16060, 57-68831, 57-101835, 59-182436, 7-36145 and 7-199409, JP-B Nos. 48-33692, 50-16648, 2-41734, and U.S. Pat. Nos. 4,088,497 4,283,487, 4,548,896 and 5,187,049. The amount of the compound used is determined depending on the aimed absorption amount and, in general, is preferably within a range of 1 μg to 1 g per 1 m² of the portion other than the light sensitive layer.

The heat developable light sensitive material of the invention may have a surface protection layer with an aim of preventing adhesion of the light sensitive layer (image forming layer). Any polymer may be used as a binder of the surface protection layer. Examples of the material for the binder include polyester, gelatin, polyvinyl alcohol and cellulose derivatives, and cellulose derivatives are preferable. Examples of the cellulose derivatives include, but are not limited to, cellulose acetate, cellulose acetate butyrate, cellulose propionate, hydroxypropyl cellulose, hydroxypropylmethyl cellulose, methyl cellulose, hydroxyethyl cellulose, carboxymethyl cellulose and mixtures thereof.

The thickness of the surface protection layer in the invention is preferably from 0.1 to 10 μm and particularly preferably 1 to 5 μm.

Any adhesion preventive material may be used in the surface protective layer. Examples of the adhesion preventive material include wax, liquid paraffin, silica particles, styrene-containing elastomeric block copolymer (for example, styrene-butadiene-styrene, and styrene-isoprene-styrene), cellulose acetate, cellulose acetate butyrate, cellulose propionate and mixtures thereof.

A photographic element including light absorbing material and filter dye as described in U.S. Pat. Nos. 3,253,921, 2,274,782, 2,527,583, and 2,956,879 can be used in the light sensitive layer or the protection layer for the light sensitive layer in the invention. Further, as described, for example, in U.S. Pat. No. 3,282,699, the dye can be mordanted. The amount of the filter dye is used such that an absorbancy of the light sensitive material is preferably 0.1 to 3 and more preferably 0.2 to 1.5 at an exposure wavelength.

The light sensitive layer or the protection layer for the light sensitive layer in the invention can contain a matting agent, for example, starch, titanium dioxide, zinc oxide, silica, polymer beads containing beads as described in U.S. Pat. Nos. 2,992,101 and 2,701,245. The degree of matting on the emulsion surface may be at any level so long as it does not cause a so-called stardust failure in which a part of the image area falls out and light leaks therefrom, and a Beck smoothness is preferably 200 to 10,000 seconds and particularly preferably 300 to 10,000 seconds.

In the heat developable light sensitive material according to the invention, the light sensitive layer is constituted with one or more of layers on a support. In a case where the sensitive layer is a single layer, it has to contain a binder, an organic silver salt, a reducing agent for silver ion and light sensitive sliver halide grains, and may contain an additional material such as a color controlling agent, a covering aid and other auxiliaries. In a case where the light sensitive layer is composed of the first and second layers, the first layer (usually a layer adjacent to the support) has to contain an organic silver salt and a light sensitive silver halide grains and the second layer or both of the layers have to contain other components. The light sensitive material of the invention may have a specific constitution including a single light sensitive layer containing all of essential components and a protection top coat. The constitution of a heat developable multi-color light sensitive photographic material may contain the combination of such two layers for each color-forming layer and, further, all of the essential components may be incorporated in one single layer as described in U.S. Pat. No. 4,708,928. In a case of a heat developable multi-dye and multi-color light sensitive photographic material, the light sensitive layers are generally separated from each other by disposing a functional or non-functional barrier layer between each of the light sensitive layers, as described in U.S. Pat. No. 4,460,681.

In the heat developable light sensitive material of the invention, a so-called one-side light sensitive material having a light sensitive layer containing at least one layer of a silver halide emulsion on one surface of a support and having a back layer on another surface of the support is preferable.

The heat developable light sensitive material of the invention may contain a matting agent in order to improve the transportability. The matting agent is generally organic or inorganic water-insoluble fine particles. Any matting agent may be used and those well-known in the art can be used such as organic matting agents described in U.S. Pat. Nos. 1,939,213, 2,701,245, 2,322,037, 3,262,782, 3,539,344 and 3,767,448, and inorganic matting agents described in U.S. Pat. Nos. 1,260,772, 2,192,241, 3,257,206, 3,370,951, 3,523,022 and 3,769,020. Specifically, typical examples of organic compounds usable as the matting agent include vinyl polymers that can be dispersed in water, such as polymethyl acrylate, polymethyl methacrylate, polyacrylonitrile, acrylonitrile-α-methylstyrene copolymer, polystyrene, styrene-divinylbenzene copolymer, polyvinyl acetate, polyethylene carbonate and polytetrafluoroethylene, cellulose derivatives such as methyl cellulose, cellulose acetate and cellulose acetate propionate, starch derivatives such as carboxy starch, carboxynitrophenyl starch and urea-formaldehyde starch reaction product, gelatin hardened by a known hardening agent and hardened gelatin formed by coacervate hardening into fine hollow capsule particles. Typical examples of the inorganic compound include silicon dioxide, titanium dioxide, magnesium dioxide, aluminum oxide, barium sulfate, calcium carbonate, silver chloride desensitized by a known method, and silver bromide, glass and diatomaceous earth. Different kinds of the matting agent may be used in admixture, if necessary. There is no particular restriction on the shape of the matting agent and any shape can be used. In the invention, those having an average grain size of 1 μm to 30 μm, and more preferably 3 μm to 10 μm are used preferably. In the grain size distribution of the matting agent, the fluctuation coefficient is preferably 50% or less. On the other hand, since the matting agent gives a significant effect on the haze and the surface gross of the light sensitive material, it is preferable to adjust the grain size, the shape and the grain size distribution into a required state by mixing a plurality of matting agents or in the preparation of the matting agent.

In the invention, the layer that can contain the matting agent may be an outermost layer of the light sensitive layer side and the back surface side (which may be a light sensitive layer or a back layer), or a protection layer, or an undercoating layer. The matting agent is preferably incorporated in the outermost surface layer, or a layer that functions as the outermost surface layer, or in a layer close to the outer surface, or it is preferably contained in a layer that functions as a protection layer.

In the invention, the degree of matting of the back surface (Beck smoothness) is preferably 10 to 250 seconds and more preferably 50 to 180 seconds.

In the invention, a suitable binder for the back layer is transparent or semitransparent and generally colorless, and examples thereof include natural polymer, synthetic resin, polymer and copolymer, and other film forming media such as gelatin, gum Arabic, polyvinyl alcohol, hydroxyethyl cellulose, cellulose acetate, cellulose acetate butylate, polyvinylpyrrolidone, casein, starch, polyacrylic acid, polymethylmethacrylic acid, polyvinyl chloride, polymethacrylic acid, copoly(styrene-maleic acid anhydride), copoly(styrene-acrylonitrile), copoly(styrene-butadiene), polyvinyl acetals (for example, polyvinyl formal and polyvinyl butyral), polyesters, polyurethanes, phenoxy resin, polyvinylidene chloride, polyepoxides, polycarbonates, polyvinyl acetate, cellulose esters and polyamides. The binder may be used in the form of a coating solution or emulsion in which it is dissolved or dispersed in water or an organic solvent.

Further, the backside resistive heating layer as described in U.S. Pat. Nos. 4,460,681 and 4,374,921 can also be used in the heat developable light sensitive photographic image systems.

In the invention, a surfactant may be used with an aim of improving the coatability and chargeability. Any of nonionic, anionic, cationic and fluorinated surfactants may be used as such. Specific examples thereof include fluoropolymeric surfactants as described in JP-A No. 62-170950 and U.S. Pat. No. 5,380,644, fluorinated surfactants as described in JP-A Nos. 60-244945 and 63-188135, polysiloxane surfactants as described in U.S. Pat. No. 3,885,965, and polyalkylene oxides and anionic surfactants as described in JP-A No. 6-301140. Preferred surfactants among them are fluorinated surfactants: fluorinated anionic surfactants and fluorinated nonionic surfactants. Fluorinated nonionic surfactants having a fluorinated alkyl group which has 6 or less carbon atoms are particularly preferable. Specific examples of the fluorinated surfactants include compounds as described in JP-A Nos. 10-197985, 2000-19680 and 2000-214554. Further, the polymeric fluorinated surfactants described in JP-A No. 9-281636 are also preferably used. In the heat developable light sensitive material of the invention, use of the fluorinated surfactants described Japanese Patent Application Nos. 2000-206560, 2001-203462, 2001-242357 and 2001-264110 is preferable. In particular, the fluorinated surfactants described in Japanese Patent Application Nos. 2001-242357 and 2001-264110 are preferable in view of the charge controlling performance, stability of the state of the coating surface, and slipping property in a case of production by coating an aqueous coating solution and the fluorinated surfactants described in Japanese Patent Application No. 2001-264110 are most preferable since its charge controlling performance is high and the amount thereof can be decreased.

In the invention, the fluorinated surfactant may be used in the emulsion surface and/or the back surface, and it is preferably used in both of the surfaces. Further, it is particularly preferable to use it with the conductive layer containing the metal oxide described above. In this case, a sufficient performance can be obtained even when the amount of the fluorinated surfactant used in the surface side having the conductive layer is reduced.

A typical amount of the fluorinaed surfactant to be used is within a range from 0.1 mg/m² to 100 mg/m² and more preferably within a range from 0.3 mg/m² to 30 mg/m² and further preferably within a range from 1 mg/m² to 10 mg/m² to each of the emulsion surface and the back surface. In particular, the fluorinated surfactant described in Japanese Patent Application No. 2001-264110 has a large effect and it is used in an amount, preferably, within a range from 0.01 to 10 mg/m² and more preferably within a range from 0.1 to 5 mg/m².

In the invention, the following fluorinated surfactants can be preferably used.

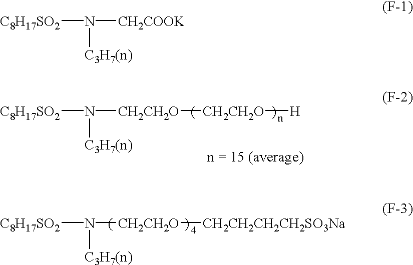

C₈F₁₇SO₃K (F-4)

CF₈(CF₂)ₙCH₂CH₂SCH₂CH₂COOLi (F-5)

a mixture of compounds with n of 5 to 11

CF₈(CF₂)ₙCH₂CH₂O(CH₂CH₂O)ₘH (F-6)

a mixture of compounds with n of 5 to 11 and m of 5 to 15

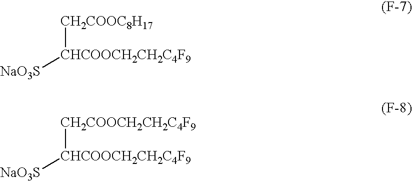

In the heat developable light sensitive material of the invention, examples of a solvent used in the coating solutions for each of the layers are described in Solvent Pocket Book, New Edition (Ohm Co., published in 1994), but the invention is not restricted to them. Further, the solvent used in the invention preferably has a boiling point of 40° C. to 180° C.

Examples of the solvent used in the invention include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N′-dimethylformamide, morpholine, propanesultone, and perfluorotributylamine.

The light sensitive layer in the invention can be formed on various supports. Typical examples of the support include polyester film, undercoated polyester film, polyethylene terephthalate film, polyethylene naphthalate film, cellulose nitrate film, cellulose ester film, polyvinyl acetal film, polycarbonate film and relevant resinous material, glass, paper and metal. Flexible substrate, particularly, a paper support partially acetylated or coated with baryta and/or α-olefin polymer, particularly, a polymer of α-olefin having 2 to 10 carbon atoms such as a polyethylene, polypropylene, ethylene-butene copolymer is typically used. While the support may be transparent or not transparent, it is preferably transparent.

The heat developable light sensitive material of the invention may also contain an antistatic or conductive layer, for example, a layer containing a soluble salt (for example, chloride and nitrate), a vapor deposited metal layer, or a layer including an ionic polymer as described in U.S. Pat. Nos. 2,861,056 and 3,206,312 or an insoluble inorganic salt as described in U.S. Pat. No. 3,428,451.

The method of obtaining color images by using the heat developable light sensitive material of the invention include a method as described in page 10, left column, line 43 to page 11, left column, line 40 of JP-A No. 7-13295. Further, as the stabilizer for color dye images, those described in British Patent No. 1,326,889, and U.S. Pat. Nos. 3,432,300, 3,698,909, 3,574,627, 3,573,050, 3,764,337, and 4,042,394 can be used.

The method of forming the heat developable light sensitive material of the invention can use various coating operations including dip coating, air knife coating, flow coating or extrusion coating using a hopper described in U.S. Pat. No. 2,681,294. If desired, two or more of layers may be coated simultaneously by the method as described in U.S. Pat. No. 2,761,791 and British Patent No. 837,095.

The heat developable light sensitive material of the invention can include an additional layer, for example, a dye receiving layer for receiving mobile dye images, an opacifying layer in a case where reflection printing is desired, a protection topcoat layer and a primer layer known in the photothermal photography technology. It is preferable that the light sensitive material of the invention can form images with only one sheet of the light sensitive material and without using other separate light sensitive material, thus eliminating a need to allot functional layers, including a light sensitive layer and an image receiving layer, which are needed for forming images, to each recording layer.

The heat developable light sensitive material of the invention may be developed by any method and it is usually developed by heating the light sensitive material exposed imagewise. A developing temperature is preferably from 80 to 250° C. and more preferably 100 to 140° C. The developing time is preferably from 1 to 180 seconds and more preferably 10 to 90 seconds.

While the heat developable light sensitive material of the invention may be exposed by any method, it is preferable to use a laser beam as an exposure light source and to scan with the laser beam from the light sensitive layer side of the light sensitive material. The scanning laser beam usable in the invention is preferably gas laser, dye laser or semiconductor laser. Further, a semiconductor laser or a YAG laser and a device for generating second harmonic wave may also be used.

In the invention, the scanning laser beam is preferably in a longitudinal multi-mode. The longitudinal multi-mode means that the exposure wave length is not single and it is usually preferable that the distribution of the exposure wavelength is 5 nm or more and preferably 10 nm or more. There is no particular restriction on the upper limit of the distribution of the exposure wavelength and it is usually about 60 nm. The longitudinal multi-mode can be obtained by a method, for example, using wave synthesis, utilization of return beam or superimposing high frequency waves. By making the laser beam longitudinal multi-mode, degradation of image quality such as occurrence of unevenness in the interference fringe is decreased compared with the scanning laser beam of longitudinal single mode.

Further, while the incident angle of the scanning laser beam to the surface of the light sensitive material is usually vertical, it is preferable that the angle is not substantially vertical in the invention. “Substantially” means herein that the angle nearest to the vertical during laser scanning is preferably 550 to 880, more preferably 60° to 86°, further preferably 65° to 84° and most preferably 70° to 82°.

In the images obtained by exposing the light sensitive material to a laser beam at such an incident angle, degradation of image quality due to uneven interference does not easily occur and sharpness and contrast are improved.

### EXAMPLES

The present invention will be described specifically by way of examples but the invention is not restricted to such examples.

### Example 1

### <<Preparation of Iridium-Doped Core-Shell Type Silver Bromoiodide Emulsion>>

After adding simultaneously a solution prepared by dissolving 27.4 g of KBr and 3.3 g of KI in 275 ml of deionized water and a solution prepared by dissolving 42.5 g of silver nitrate in 364 ml of deionized water to a first solution prepared by dissolving 30 g of gelatin phthalide and 71.4 mg of KBr in 1500 ml of deionized water and adjusting its pH to 5.0 by 3 mol/l of nitric acid and kept at 34° C., over 9.5 minutes, a solution prepared by dissolving 179 g of KBr and 10 mg of dipotassium hexachloroiridate in 812 ml of deionized water and a solution formed by dissolving 127 g of silver nitrate in 1090 g of deionized water were mixed therewith simultaneously for 28.5 min. Further, pAg was kept at a constant value by using a pAg feedback control loop as described in Research Disclosure No. 17643, U.S. Pat. Nos. 3,415,650, 3,782,954 and 3,821,002.

The thus obtained emulsion was washed with water and desalted. The average particle size was 0.045 μm. The size of the silver halide grains was determined by a transmission electron microscope (TEM).

<<Preparation of Iridium-Doped and Previously Prepared Silver Halide/Organic Silver Salt Dispersion>>

After dissolving 118 g of Humko type fatty acid 9718 (manufactured by Witco Co., Memphis, Tenn.) and 570 g of Humko type fatty acid 9022 (manufactured by Witco Co., Memphis, Tenn.) in 13 liter of water at 80° C. and mixing the resultant solution for 15 minutes, a solution prepared by dissolving 89.18 g of NaOH in 1.5 liter of water at 80° C. was added thereto and the resultant solution was stirred for 5 minutes to form a dispersion. After adding a solution prepared by diluting 319 ml of concentrated nitric acid with 50 ml of water to the dispersion at 80° C., cooling the resultant dispersion to 55° C. and then stirring it for 25 min, a silver halide emulsion, which was prepared by diluting 700 g of the above-described iridium-doped silver halide emulsion with 1.25 liters of water at 42° C., was added to the dispersion, which was kept at 55° C., so that the amount of silver halide added to the dispersion was 0.10 mol and the resultant mixture was stirred for 5 minutes at 55° C. Further, a solution prepared by dissolving 3365 g of silver nitrate in 2.5 liter of water at 55° C. was added thereto and the resultant mixture was stirred for 10 min. The thus obtained sliver halide/organic silver salt dispersion was desalted by a centrifugal filtration, washed with water and concentrated till the electroconductivity of washing water reached 2 μs/cm and then it was dried by a hot blow at 45° C. for 72 hours.

209 g of the silver halide/organic silver salt dispersion thus prepared was stirred and mixed in 780 g of methyl ethyl ketone (MEK) and 11 g of polyvinyl butyral (Butvar B-79, manufactured by Monsant Co.) for 10 min and then allowed to stand at 7° C. over one night. Further, the mixture was homogenized twice under the condition at 6000 psi (≅41 MPa) to prepare a silver soap dispersion.

Further, silver soap despersions using the same weight of other binders (shown in Table 1) instead of polyvinyl butyral were also prepared respectively.

<<Preparation of Light Sensitive Layer Coating Solution>>

507 g of previously prepared silver soap dispersion was stirred at 13° C. for 15 min, and 3.9 ml of methanol solution of 10 mass % pyridinium hydrobromide perbromide (PHP) was added thereto. After stirring the resultant mixture for 2 hours, 5.2 ml of methanol solution of 72 mass % calcium bromide was added thereto. After stirring the resultant mixture for 30 min, 117 g of Butvar B-79 was added to the resultant mixture. After further stirring the resultant mixture for 30 min, 27.3 g of 1,1-bis(2-hydroxy-3,5-dimethylphenyl)-2-methylpropane was added thereto and the resultant dispersion was stirred for 15 min. Then, after adding 2.73 g of 2-(tribromomethylsulfonyl)quinoline to the dispersion, they were stirred for 15 min. This was added to a solution prepared by dissolving 1.39 g of Desmodur N3300 (aliphatic isocyanate manufactured by Mobay Co.) in 12.3 g of MEK, and the resultant dispersion was stirred for 15 min and then heated at 21° C. for 15 min.

1 mg of colorant C, 2.2 g of 4-chlorobenzophenone-2-carboxyric acid, 0.47 g of 2-chlorobenzoic acid and 0.47 g of 5-methyl-2-mercaptobenzimidazol were added to 100 g of the dispersion and they were stirred at 21° C. for one hour. Then, 0.368 g of phthalazine, 0.123 g of tetrachlorophthalic acid, 2 g of dye C and an amount of mercury acetate as a mercury compound, which amount would provide the coated amount shown in Table 1, were added to the resultant dispersion and the aziridine compound, epoxy compound or carbodiimide compound according to the invention was added to the resultant dispersion such that a coated amount thereof shown in Table 1 was obtained, to obtain a light sensitive layer coating solution.

<<Preparation of Surface Protection Layer Coating Solution>>

61 g of methanol, 48 g of cellulose acetate butyrate (CAB171-15S, manufactured by Eastman Chemical Co.), 2.08 g of 4-methylphthalic acid, 3.3 g of an MEK solution of 16 mass % of fluoropolymeric surfactant C, 1.9 g of polymethylmethacrylic acid (Acryliod A-21 manufactured by Rohm & Haas Co.) and 0.5 g of 1,3-di(vinylsulfonyl)-2-propanol were mixed with 512 g of MEK at a room temperature to prepare a surface protection layer coating solution.

<< Coating of undercoating lower layer for back surface>>

| | |
|---|---|
| Julimer ET-410 (manufactured by Nippon Jun-yaku Co.) | 95 mg/m² |
| SnO₂/Sb (weight ratio: 9/1, needle-shaped | |
| particles, trade name of products: FS-10D, | |
| manufactured by Ishihara Sangyo Co.) | |
| addition amount shown in Table 1 | |
| Cross-linking agent (Denacol EX-614B, | |
| manufactured by Nagase Kasei Industry Co.) | 17 mg/m² |

<< coating of undercoating upper layer for back surface>>

| | |
|---|---|
| Latex binder (Chemipearl S-120, manufactured by | 1070 mg/m² |
| Mitsui petrochemical Co.) | |
| Colloidal silica (Snowtex-C, manufactured by | 40 mg/m² |
| Nissan Chemical Co.) | |
| Cross-linking agent (Denacol EX-614B, | 215 mg/m² |
| manufactured by Nagase Kasei Industry Co.) | |

The undercoating lower layer and upper layer were successively formed on a blue-tinted polyethylene terephthalate support having a thickness of 176 μm and then dried at 180° C. for 4 min respectively.

A sample using silver-doped vanadium pentoxide instead of SnO₂/Sb used in undercoating lower layer was also formed.

<<Coating of Back Surface>>

0.9 g of dye C and 78.7 g of MEK were added to 786.7 g of an MEK solution of 12.6 mass % of cellulose acetate butyrate (CAB380-20, manufactured by Eastman Chemical Co.) and 0.17 mass % of polyester (Vitel TM PE-200, manufactured by Goodyear Co.) and then 78.7 g of dispersion in which 0.38 mass % of a silica matting agent having an average particle size of 8 μm and a fluctuation coefficient of 40% was dispersed in MEK was added thereto. Further, 15.7 g of an antistatic agent C and 3.93 g of MEK were added to the resultant dispersion and the resultant dispersion was stirred to obtain a back surface coating solution.

The thus obtained back surface coating solution was coated on the undercoating layers and the coating layer was dried and a thickness thereof was 76 μm. The transmission density (absorbancy) was 0.39 to a light having a wavelength of 800 nm.

<<Preparation of Light Sensitive Material>>

Then, the light sensitive layer coating solution and the surface protection layer coating solution were coated simultaneously on the support by a dual knife coater. The light sensitive layer coating solution was coated on the support so as to provide a silver coated amount shown in Table 1. The surface protection layer coating solution was coated on the light sensitive layer to a wet thickness corresponding to a dry film thickness of 3.4 μm. The coating apparatus comprised two knife coating blades arranged side by side. After cutting the support to a length corresponding to the volume of the solution used, knives with a hinge were elevated and positioned above the coater floor. Then, the knives were lowered and set to a predetermined position. The height of the knives was controlled by using a wedge controlled by a screw knob and measured by a current meter. Knife #1 was elevated to an interval corresponding to a thickness, which was a total of the thickness of the support and a desired wet thickness of the light sensitive layer (layer #1). Knife #2 was elevated to a height equal to a desired thickness, which was a total of the support thickness, the desired wet thickness of the light sensitive layer (layer #1), and the desired thickness of the top coat layer (layer #2).

Chemical structures of the compound used in Example 1 are shown below.

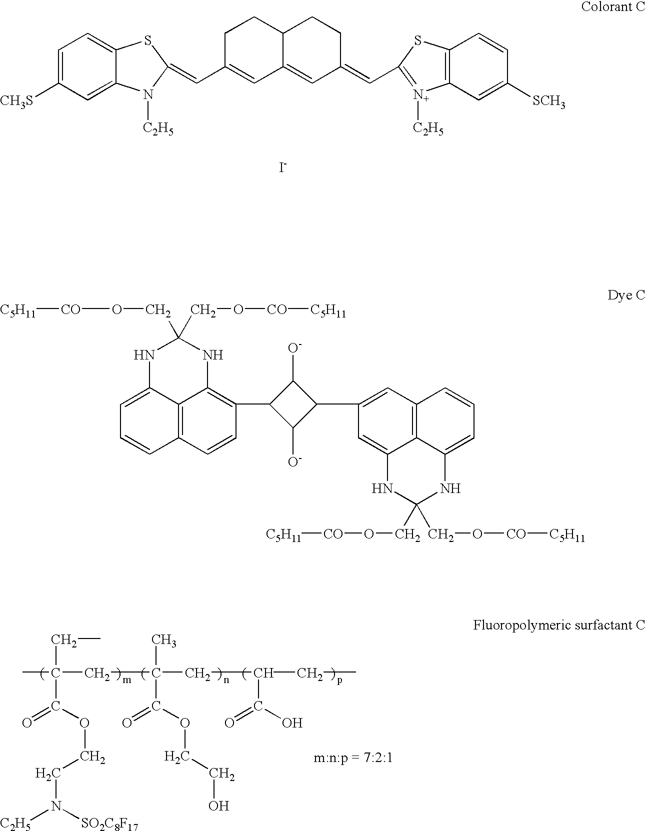

Antistatic Agent C

C₈F₁₇—SO₃⁻H₃^{+N}(CH₂—CH₂—O)₁₂CH₂—CH₂—NH₃⁺C₈F₁₇—SO₃⁻

Measurement of Sensitivity

The coated and dried light sensitive material was cut into test materials of 10 inch×8 inch (25.4 cm×20.3 cm), and the test materials were exposed to light by an exposure equipment using as an exposure source a semiconductor laser having a wavelength of 800 nm to 820 nm and made a longitudinal multi-mode by superimposing high frequency waves on the light of above described wavelength. The laser beam was applied at an incident angle of 750 relative to the surface of the light sensitive material. After exposure, the test materials were heated at 124° C. for 15 seconds and developed by using an automatic developing machine having a heating drum such that the protection layer of the light sensitive material and the drum surface were brought into contact with each other and then images were obtained. Then, the obtained images were evaluated by a commercially available densitometer.

Evaluation of Transportability

100 sheets of the materials were transported continuously in an environment of 25° C. and RH 20%, and the number of sheets suffering from transportation failure was counted.

Evaluation of Fogging

The 100th light sensitive material which had not been exposed used in the evaluation of the transportability was thermally developed by the same method as the measurement of sensitivity to evaluate fogging.

The results of evaluation are shown in Table 1.

TABLE 1

| | | | | | Conductive | | | Ag | | Transport- | | |
|---|---|---|---|---|---|---|---|---|---|---|---|---|
| | | | Additive | | material | | Log | coated | | ability | | |
| Material | | Hg | | Amount | | Amount | ER | amount | Sensi- | (Number of | Fogging | |
| No. | Binder | (mg/m²) | Kind | (mol/m²) | Kind | (mg/m²) | value | (g/m²) | tivity | sheet) | value | Remarks |
| 1 | *1 | 0 | — | — | SnO₂ | 100 | 11.7 | 1.8 | 100 | 0 | 0.05 | Invention |
| 2 | *2 | 0 | — | — | SnO₂ | 100 | 11.5 | 1.8 | 102 | 1 | 0.05 | Invention |
| 3 | *3 | 0 | — | — | SnO₂ | 100 | 11.8 | 1.8 | 101 | 3 | 0.09 | Comp. Ex. |
| 4 | *4 | 0 | — | — | SnO₂ | 100 | 11.6 | 1.8 | 100 | 4 | 0.08 | Comp. Ex. |
| 5 | *5 | 0 | — | — | SnO₂ | 100 | 11.7 | 1.8 | 102 | 4 | 0.09 | Comp. Ex. |
| 6 | *1 | 0.5 | — | — | SnO₂ | 100 | 11.5 | 1.8 | 100 | 1 | 0.06 | Invention |
| 7 | *1 | 1.5 | — | — | SnO₂ | 100 | 11.3 | 1.8 | 99 | 2 | 0.13 | Comp. Ex. |
| 8 | *1 | 0 | — | — | V₂O₅ | 100 | 11.8 | 1.8 | 100 | 1 | 0.05 | Invention |
| 9 | *1 | 0.5 | — | — | V₂O₅ | 100 | 11.5 | 1.8 | 100 | 1 | 0.06 | Invention |
| 10 | *1 | 1.5 | — | — | V₂O₅ | 100 | 11.2 | 1.8 | 97 | 2 | 0.14 | Comp. Ex. |
| 11 | *1 | 0 | AZ-2 | 0.003 | — | 0 | 15.3 | 1.8 | 98 | 15 | 0.05 | Comp. Ex. |
| 12 | *1 | 0 | AZ-2 | 0.003 | SnO₂ | 20 | 13.2 | 1.8 | 100 | 10 | 0.05 | Comp. Ex. |
| 13 | *1 | 0 | AZ-2 | 0.003 | SnO₂ | 100 | 11.6 | 1.8 | 100 | 0 | 0.05 | Invention |
| 14 | *1 | 0 | AZ-2 | 0.003 | SnO₂ | 200 | 10.4 | 1.8 | 103 | 0 | 0.05 | Invention |
| 15 | *1 | 0 | EP-2 | 0.003 | SnO₂ | 100 | 11.2 | 2.3 | 98 | 4 | 0.07 | Comp. Ex. |
| 16 | *1 | 0 | EP-2 | 0.003 | SnO₂ | 100 | 11.5 | 1.8 | 100 | 1 | 0.05 | Invention |
| 17 | *1 | 0 | EP-2 | 0.003 | SnO₂ | 100 | 11.5 | 1.3 | 101 | 0 | 0.04 | Invention |
| 18 | *2 | 0 | — | — | V₂O₅ | 100 | 11.7 | 1.8 | 100 | 0 | 0.05 | Invention |
| 19 | *2 | 0.5 | — | — | V₂O₅ | 100 | 11.6 | 1.8 | 102 | 0 | 0.06 | Invention |
| 20 | *2 | 1.5 | — | — | V₂O₅ | 100 | 11.5 | 1.8 | 97 | 2 | 0.15 | Comp. Ex. |
| 21 | *2 | 0 | AZ-2 | 0.003 | — | 0 | 15.6 | 1.8 | 99 | 13 | 0.05 | Comp. Ex. |
| 22 | *2 | 0 | AZ-2 | 0.003 | SnO₂ | 20 | 13.4 | 1.8 | 98 | 9 | 0.05 | Comp. Ex. |
| 23 | *2 | 0 | AZ-2 | 0.003 | SnO₂ | 100 | 11.6 | 1.8 | 101 | 0 | 0.05 | Invention |
| 24 | *2 | 0 | AZ-2 | 0.003 | SnO₂ | 200 | 10.1 | 1.8 | 100 | 0 | 0.05 | Invention |
| 25 | *2 | 0 | EP-2 | 0.003 | V₂O₅ | 100 | 11.2 | 2.3 | 99 | 4 | 0.07 | Comp. Ex. |
| 26 | *2 | 0 | EP-2 | 0.003 | V₂O₅ | 100 | 11.6 | 1.8 | 100 | 1 | 0.05 | Invention |
| 27 | *2 | 0 | EP-2 | 0.003 | V₂O₅ | 100 | 11.5 | 1.3 | 100 | 0 | 0.04 | Invention |
| 28 | *3 | 0 | AZ-4 | 0.003 | SnO₂ | 100 | 11.7 | 1.8 | 101 | 3 | 0.07 | Comp. Ex. |
| 29 | *4 | 0 | AZ-4 | 0.003 | SnO₂ | 100 | 11.5 | 1.8 | 98 | 4 | 0.06 | Comp. Ex. |

Binder:
*1 Polyvinyl butyral
*2 Cellulose acetate butyrate
*3 Polystyrene
*4 Polyurethane made from diphenylmethane diisocyanate/neopentyl glycol/cyclohexyl dimethanol/isophthalic acid/phthalic acid
Conducive material:
SnO₂; Sb-doped tin oxide
V₂O₅; Ag-doped vanadium pentaoxide

As apparent from Table 1, it can be seen that the heat developable heat developable light sensitive material according to the present invention suffers from no occurrence of fogging and is excellent in the transportability.

### Example 2

Preparation of Support

Both surfaces of a PET film having a thickness of 175 μm and colored blue to a density of 0.160 was subjected to a corona discharging treatment at 8 W/m²·min.

[Preparation of Light Sensitive Emulsion]

Preparation of Light Sensitive Silver Halide Emulsion

After dissolving 7.5 g of ossein gelatin with an average molecular weight of 100,000 and 10 mg of potassium bromide in 900 ml of water and adjusting the temperature and pH of the resultant solution to 35° C. and 3.0, respectively, 370 ml of an aqueous solution containing 74 g of silver nitrate and 370 ml of an aqueous solution containing potassium bromide and potassium iodide at a molar ratio (98/2) and iridium chloride in an amount of 1×10⁻⁴ mol per mol of silver were added to the solution by a controlled double jet method over 10 min while keeping pAg at 7.7. Then, 0.3 g of 4-hydroxy-6-methyl-1,3,3a,7-tetrazaindene was added to the resultant mixture, and pH of the resultant mixture was adjusted to 5 by NaOH to obtain cubic silver iodobromide grains with an average particle size of 0.06 μm, a fluctuation coefficient of the particle size of 12% and [100] plane percentage of 87%. After flocculating and settling down the silver halide grains with a gelatin flocculating agent and subjecting a desalt processing, 0.1 g of phenoxyethanol was added to the emulsion and pH and pAg of the emulsion were adjusted to 5.9 and 7.5, respectively, to obtain a light sensitive silver halide emulsion.

The temperature of the light sensitive silver halide emulsion was elevated to 55° C. and 5×10⁻⁵ mol of the compound A of the following formula was added to the emulsion. Successively, 7×10⁻⁵ mol of ammonium thiocyanate and 5.3×10⁻⁵ mol of chloroauric acid were added thereto. Further, 0.3 mol % of fine silver iodide grains was added to the resultant emulsion. After aging the resultant emulsion for 100 min, the emulsion was cooled to 38° C. to complete chemical sensitization and obtain silver halide grains. The addition amount was a value per mol of AgX.

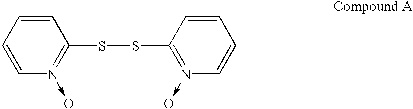

Preparation of Powdery Organic Silver Salt

111.4 g of behenic acid, 83.8 g of arachidic acid and 54.9 g of stearic acid were dissolved in 4720 ml of purified water at 80° C. Then, after adding 540.2 ml of a 1.5 M aqueous solution of sodium hydroxide and 6.9 ml of concentrated nitric acid to the solution while stirring at a high speed, the resultant solution was cooled to 55° C. to obtain a solution of sodium salt of an organic acid. While keeping the temperature of the solution of sodium salt of the organic acid at 55° C., silver halide grains (containing 0.038 mol of silver) and 450 ml of purified water were added to the solution and the resultant mixture was stirred for 5 min. Then, 760.6 ml of a 1 M solution of silver nitrate was added to the mixture over 2 min, and the resultant mixture was stirred for 20 min and water soluble salts were removed therefrom by filtration. Then, washing with deionized water and filtration were repeated until the electroconductivity of the filtrate reached 2 μS/cm and, after centrifugal dehydration, the residue was dried under a heated nitrogen gas stream until weight reduction ceased, to obtain a powdery organic silver salt.

Preparation Dispersion of Light Sensitive Emulsion

14.57 g of polyvinyl butyral powder (Butvar B-79, manufactured by Monsanto Co.) was dissolved in 1457 g of methyl ethyl ketone, and 500 g of the powdery organic silver salt described above was gradually added to and mixed sufficiently with the solution while stirring by a dissolver type homogenizer. Then, a dispersion of a light sensitive emulsion was prepared by dispersing the mixture at a circumferential speed of 13 m for 0.5 minutes in a media-type disperser (manufactured by Gettzmann Co.), which was 80% filled with 1 mm-diameter Zr beads (manufactured by Toray Co.)

[Preparation of Light Sensitive Layer Coating Solution]

100 g of methyl ethyl ketone (MEK) was added to 500 g of the dispersion of the light sensitive emulsion described above under a nitrogen gas stream while stirring the dispersion and the resultant mixture was kept at a temperature of 24° C. The following anti-foggant 1 (2.50 ml of 10% methanol solution) was added to the mixture and the resultant mixture was stirred for 1 hour and calcium bromide (4 ml of 10% methanol solution) was added thereto and the resultant mixture was stirred for 15 minutes. 1.8 ml of a mixture (20 wt % ethanol solution of dye adsorption aid) containing the following dye adsorption aid and potassium acetate in a ratio of 1:5 was added to the mixture and the resultant mixture was stirred for 15 minutes. Then, after adding a mixed solution of the infrared sensitizing dye identical with that in Example 1 (dye C), 4-chloro-2-benzoylbenzoic acid, and super sensitizing agent (5-methyl-2-mercaptobenzimidazole) (mixing ratio: 1:250:20, 7 ml of 0.1% methanol solution of sensitizing dye) and stirring them for one hour, the temperature of the resultant mixture was lowered to 13° C. and the mixture was further stirred for 30 minutes. While keeping the temperature thereof at 13° C., 48 g of polyvinyl butyral was added thereto and dissolved sufficiently and then the following additives were added to the resultant mixture (all of the procedures were conducted under a nitrogen gas stream).

| | |
|---|---|
| Phthalazine | 1.5 g |
| tetrachlorophthalic acid | 0.5 g |
| 4-methylphthalic acid | 0.5 g |
| Dye identical with that in Example 1 | an amount such |
| | that an |
| | absorbancy of |
| | the absorption |
| | maximum of the |
| | dye was 0.9 |
| Developer (1,1-bis(2-hydroxy-3,5-dimethyl- | 15 g |
| phenyl)-2-methylpropane) | |
| Desmodur N3300 (aliphatic isocyanate, manufactured | 1.10 g |
| by Mobey Co.) | |
| Anti-foggant 2 (2-(tribromomethyl- | 1.55 g |
| sulfonyl)-quinoline) | |
| Anti-foggant 3 (the following formula) | 0.9 g |

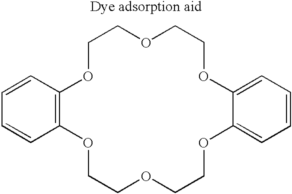

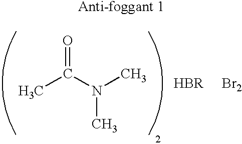

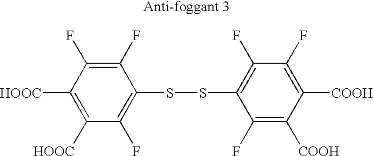

<Coating on the Light Sensitive Layer Side>

Light sensitive layer: Liquids of the compositions described above were coated on the support, respectively, such that the coated amount of silver was that shown in Table 2, an amount of polyvinyl butyral as a binder was 8.5 g/m² and the coated amounts of the aziridine compound, the epoxy compound or the carbodiimide compound of the invention were those shown in Table 2.

<Surface Protection Layer>

The solution of the following composition was coated on each of the light sensitive layers to a wet thickness of 100 μm.

| | |
|---|---|
| Acetone | 175 ml |
| 2-propanol | 40 ml |
| Methanol | 15 ml |
| Cellulose acetate | 8 g |
| Phthalazinone (4.5 % DMF solution) | 8 ml |
| Phthalazine | 1.5 g |
| 4-methylphthalic acid | 0.72 g |
| Tetrachlorophthalic acid | 0.22 g |
| Tetrachlorophthalic acid anhydride | 0.5 g |
| Monodispersed silica with an average grain size | 1 wt % based |
| of 4 μm (fluctuation coefficient 20%) | |
| on an amount of binder | |
| Fluorinated surfactant (F-8 described | 0.5 g |
| in the specification) | |

<Coating on the Back Surface Side>

An undercoating lower layer, and an undercoating upper layer for a back surface, and a back surface coating solution identical with those in Example 1 were coated in the same manner as in Example 1.

The results of the evaluation are shown in Table 2.

TABLE 2

| | | | | | Conductive | | | Ag | | Transport- | | |
|---|---|---|---|---|---|---|---|---|---|---|---|---|
| | | | Additvive | | material | | Log | coated | | ability | | |
| Material | | Hg | | Amount | | Amount | ER | amount | Sensi- | (Number of | Fogging | |
| No. | Binder | (mg/m²) | Kind | (mol/m²) | Kind | (mg/m²) | value | (g/m²) | tivity | sheet) | value | Remarks |
| 1 | *1 | 0 | AZ-3 | 0.003 | — | — | 16.2 | 1.8 | 100 | 18 | 0.05 | Comp. Ex. |
| 2 | *1 | 0 | AZ-3 | 0.003 | SnO₂ | 20 | 14 | 1.8 | 101 | 11 | 0.05 | Comp. Ex. |
| 3 | *1 | 0 | AZ-3 | 0.003 | SnO₂ | 100 | 11.6 | 1.8 | 102 | 4 | 0.05 | Invention |
| 4 | *1 | 0 | AZ-3 | 0.003 | SnO₂ | 200 | 9.8 | 1.8 | 99 | 0 | 0.06 | Invention |
| 5 | *1 | 0 | AZ-3 | 0.003 | SnO₂ | 100 | 11.7 | 2.3 | 101 | 3 | 0.09 | Comp. Ex. |
| 6 | *1 | 0 | AZ-3 | 0.003 | SnO₂ | 100 | 11.5 | 1.3 | 100 | 0 | 0.04 | Invention |
| 7 | *1 | 0 | AZ-3 | 0.003 | V₂O₅ | 20 | 13.8 | 1.8 | 100 | 10 | 0.05 | Comp. Ex. |
| 8 | *1 | 0 | AZ-3 | 0.003 | V₂O₅ | 100 | 11.5 | 1.8 | 101 | 0 | 0.06 | Invention |
| 9 | *1 | 0 | AZ-3 | 0.003 | V₂O₅ | 200 | 10.1 | 1.8 | 103 | 0 | 0.05 | Invention |
| 10 | *1 | 0 | AZ-3 | 0.003 | V₂O₅ | 100 | 11.6 | 2.3 | 99 | 4 | 0.07 | Comp. Ex. |
| 11 | *1 | 0 | AZ-3 | 0.003 | V₂O₅ | 100 | 11.4 | 1.3 | 101 | 0 | 0.04 | Invention |
| 12 | *1 | 0 | — | — | — | — | 15.9 | 1.8 | 100 | 17 | 0.05 | Comp. Ex. |
| 13 | *1 | 0 | — | — | SnO₂ | 20 | 13.8 | 1.8 | 103 | 10 | 0.05 | Comp. Ex. |
| 14 | *1 | 0 | — | — | SnO₂ | 100 | 11.5 | 1.8 | 99 | 0 | 0.05 | Invention |
| 15 | *1 | 0 | — | — | SnO₂ | 200 | 10.1 | 1.8 | 100 | 0 | 0.05 | Invention |
| 16 | *1 | 0 | — | — | SnO₂ | 100 | 11.6 | 2.3 | 101 | 5 | 0.09 | Comp. Ex. |
| 17 | *1 | 0 | — | — | V₂O₅ | 100 | 11.4 | 1.3 | 101 | 0 | 0.04 | Invention |
| 18 | *1 | 0 | EP-8 | 0.003 | — | — | 15.9 | 1.8 | 102 | 15 | 0.05 | Comp. Ex. |
| 19 | *1 | 0 | EP-8 | 0.003 | V₂O₅ | 20 | 13.8 | 1.8 | 98 | 9 | 0.05 | Comp. Ex. |
| 20 | *1 | 0 | EP-8 | 0.003 | V₂O₅ | 100 | 11.5 | 1.8 | 100 | 0 | 0.05 | Invention |
| 21 | *1 | 0 | EP-8 | 0.003 | V₂O₅ | 200 | 10.1 | 1.8 | 98 | 0 | 0.06 | Invention |
| 22 | *1 | 0 | Ep-8 | 0.003 | V₂O₅ | 100 | 11.6 | 2.3 | 101 | 3 | 0.09 | Comp. Ex. |
| 23 | *1 | 0 | EP-8 | 0.003 | V₂O₅ | 100 | 11.4 | 1.3 | 100 | 0 | 0.04 | Invention |
| 24 | *1 | 0 | EP-16 | 0.003 | — | — | 15.9 | 1.8 | 99 | 16 | 0.05 | Comp. Ex. |
| 25 | *1 | 0 | EP-16 | 0.003 | SnO₂ | 20 | 13.8 | 1.8 | 102 | 11 | 0.05 | Comp. Ex. |
| 26 | *1 | 0 | EP-16 | 0.003 | SnO₂ | 100 | 11.5 | 1.8 | 100 | 0 | 0.05 | Invention |
| 27 | *1 | 0 | Ep-16 | 0.003 | SnO₂ | 200 | 10.1 | 1.8 | 101 | 0 | 0.06 | Invention |
| 28 | *1 | 0 | EP-16 | 0.003 | SnO₂ | 100 | 11.6 | 2.3 | 99 | 3 | 0.09 | Comp. Ex. |
| 29 | *1 | 0 | EP-16 | 0.003 | SnO₂ | 100 | 11.4 | 1.3 | 100 | 0 | 0.04 | Invention |

Binder
*1 Polyvinyl butyral
Conducive material:
SnO₂; Sb-doped tin oxide
V₂O₅; Ag-doped vanadium pentaoxide

As apparent from Table 2, it can be seen that the heat developable light sensitive material according to the invention shows no occurrence of fogging and is excellent in transportability.

What is claimed is:

1. A heat developable light sensitive material comprising a support and a constituent layer disposed on one surface of the support and including a light sensitive layer, wherein the constituent layer includes a binder, an organic silver salt, a reducing agent for silver ion, light sensitive silver halide grains, and at least one polymer binder selected from a group consisting of polyvinyl butyral, cellulose acetate, cellulose butyrate and derivatives thereof, and a mercury content of the constituent layer is no more than 1 mg/m², and a logarithmic value of the cross sectional resistance value (Ω) of the light sensitive material is no more than 12, and a coated amount of silver is no more than 1.9 g/m².

2. The heat developable light sensitive material of claim 1, wherein at least one of the constituent layer and a layer disposed on another surface of the support includes at least one of a conductive metal compound and a conductive polymer.

3. The heat developable light sensitive material of claim 2, wherein the conductive metal compound is at least one material selected from a group consisting of tin oxide, zinc oxide, titanium oxide and vanadium pentoxide.

4. The heat developable light sensitive material of claim 1, wherein at least one of the constituent layer and a layer disposed on another surface of the support includes at least one compound selected from a group consisting of aziridine compounds, epoxy compounds and carbodiimide compounds.

5. The heat developable light sensitive material of claim 1, wherein at least one of the constituent layer and a layer disposed on another surface of the support includes a matting agent having an average grain size of 3 to 10 μm and a fluctuation coefficient of no more than 50%.

6. The heat developable light sensitive material of claim 1, wherein at least one of the constituent layer and a layer disposed on another surface of the support includes a fluorinated surfactant.

7. The heat developable light sensitive material of claim 6, wherein the fluorinated surfactant has a fluorinated alkyl group which includes no more than 6 carbon atoms.

8. The heat developable light sensitive material of claim 1, wherein the coated amount of silver is no more than 1.4 g/m².

9. The heat developable light sensitive material of claim 1, wherein the logarithmic value of the cross sectional resistance value (Ω) of the light sensitive material is no more than 11.

10. The heat developable light sensitive material of claim 2, wherein the at least one of the constituent layer and the layer disposed on another surface of the support includes at least one compound selected from a group consisting of aziridine compounds, epoxy compounds and carbodiimide compounds.

11. The heat developable light sensitive material of claim 2, wherein the at least one of the constituent layer and the layer disposed on another surface of the support includes a matting agent having an average grain size of 3 to 10 μm and a fluctuation coefficient of no more than 50%.

12. The heat developable light sensitive material of claim 2, wherein the at least one of the constituent layer and the layer disposed on another surface of the support includes a fluorinated surfactant.

13. The heat developable light sensitive material of claim 12, wherein the fluorinated surfactant has a fluorinated alkyl group which includes no more than 6 carbon atoms.

14. The heat developable light sensitive material of claim 2, wherein the coated amount of silver is no more than 1.4 g/m².

15. The heat developable light sensitive material of claim 2, wherein the logarithmic value of the cross sectional resistance value (Ω) of the light sensitive material is no more than 11.

16. An image forming method comprising the step of: exposing a heat developable light sensitive material of claim 1 with a scanning laser beam thereby forming images, wherein an angle formed between the surface of the heat developable light sensitive material to be exposed and the scanning laser beam is substantially not vertical.

17. The image forming method of claim 16, wherein the angle formed between the surface of the heat developable light sensitive material to be exposed and the scanning laser beam is from 55 to 88°.

18. The image forming method of claim 16, wherein the scanning laser beam is in a longitudinal multi-mode.

19. An image forming method comprising the step of: exposing a heat developable light sensitive material of claim 1 with a scanning laser beam thereby forming images, wherein the scanning laser beam is in a longitudinal multi-mode.

20. The image forming method of claim 18, wherein the distribution of the exposure wavelength is at least 5 nm.
